(19) United States
(12) Patent Application Publication
(10) Pub. No.: US 2026/0065460 A1
(43) Pub. Date: Mar. 5, 2026

(54) APPARATUS AND METHOD FOR DETECTING ELECTRODE SHEET, APPARATUS FOR TRANSPORTING ELECTRODE SHEET

(71) Applicant: SAMSUNG SDI CO., LTD., Yongin-si (KR)

(72) Inventors: Sung Won LEE, Suwon-si (KR); Joon Kil KIM, Suwon-si (KR); Sang Heon HEO, Suwon-si (KR)

(21) Appl. No.: 19/239,520

(22) Filed: Jun. 16, 2025

(30) Foreign Application Priority Data
Sep. 5, 2024 (KR) 10-2024-0121044

(51) Int. Cl. G06T 7/00; G01N 21/55; H01M 4/04

(52) U.S. Cl. CPC G06T 7/0008; H01M 4/04; G01N 21/55

(57) ABSTRACT

An apparatus and a method for detecting an electrode sheet, and an apparatus for transporting an electrode sheet are disclosed. An apparatus for detecting an electrode sheet includes a lighting member configured to emit light to a transport conveyor, a sensor configured to detect reflected light formed by the light emitted from the lighting member and reflected from a supply region, and a processor configured to analyze a target image of the supply region generated on the basis of a result of the sensor detecting the reflected light and determine whether the electrode sheet is present in the supply region.

### CROSS-REFERENCE TO RELATED APPLICATION

The present application claims priority to and the benefit of Korean Patent Application No. 10-2024-0121044, filed on Sep. 5, 2024 in the Korean Intellectual Property Office, the entire disclosure of which is incorporated herein by reference.

### BACKGROUND

### 1. Field

Aspects of embodiments of the present disclosure relate to an apparatus and method for detecting an electrode sheet, and an apparatus for transporting an electrode sheet.

### 2. Description of the Related Art

Generally, with the recent rapid spread of electronic devices using batteries, such as mobile phones, notebook computers, and electric vehicles, the demand for secondary batteries having high energy density and high capacity is rapidly increasing. Therefore, research and development for improving the performance of lithium secondary batteries is actively being conducted.

An electrode assembly of the secondary battery may be formed by a stack process of stacking electrode sheets. A stack manufacturing apparatus performs an operation of cutting an electrode plate material supplied in the form of a reel to form electrode sheets, transporting the formed electrode sheets to a conveyor, and stacking the electrode sheets.

In the case of the conventional stack manufacturing apparatus, a situation, in which a plurality of electrode sheets overlap on a conveyor due to errors in electronic systems or the like, may occur. If a stack process is performed in such a state, there is a problem that the electrode sheet may be damaged or damage to an adjacent device may occur.

The above-described information disclosed in the technology that forms the background of the present disclosure is provided to improve understanding of the background of the present disclosure, and thus may include information that does not constitute the related art.

### SUMMARY

According to aspects of embodiments of the present disclosure an apparatus and method for detecting an electrode sheet and an electrode sheet transporting apparatus capable of preventing or substantially preventing a plurality of electrode sheets from overlapping on a conveyor are provided.

However, aspects and objects that the present invention intends to achieve are not limited to the above-described aspects and objects, and other aspects and objects that are not described may be clearly understood by those skilled in the art from the following description.

According to one or more embodiments of the present invention, an apparatus for detecting an electrode sheet includes a lighting member configured to emit light to a transport conveyor, wherein the transport conveyor includes a supply region for receiving an electrode sheet and transports the electrode sheet, and the lighting member emits light to the supply region; a sensing member, or sensor, configured to detect reflected light formed by the light emitted from the lighting member and reflected from the supply region; and a processor configured to analyze a target image of the supply region generated on the basis of a result of the sensing member detecting the reflected light and determine whether the electrode sheet is present in the supply region.

The processor may be configured to determine whether the electrode sheet is present in the supply region in a manner in which the target image is analyzed on the basis of a pixel intensity of each of a plurality of pixels constituting the target image.

The processor may be configured to determine whether the electrode sheet is present in the supply region in a manner in which a number of valid pixels with a pixel intensity that is greater than or equal to a defined (e.g., predefined) reference intensity is determined among the plurality of pixels constituting the target image.

The processor may be configured to generate a binarized image by binarizing the plurality of pixels on the basis of a value difference between the pixel intensity of each of the plurality of pixels constituting the target image and a reference intensity, determine one or more contours by clustering the valid pixels present in the binarized image, and determine whether the electrode sheet is present in the supply region based on the number of valid pixels included in the one or more contours.

The one or more contours may include first to N^{th} contours, where N is a natural number greater than or equal to 2, and if the number of valid pixels included in each of the first to N^{th} contours is defined as the number of first to N^{th} pixels, the processor may determine that the electrode sheet is present in the supply region if a maximum value of the number of first to Nₜₕ pixels is greater than or equal to a defined (e.g., predefined) number of reference pixels.

The processor may be configured to determine whether the electrode sheet is present in the supply region on the basis of a pixel intensity of the target edge determined according to a target edge determination condition defined (e.g., predefined) by considering a variance in pixel intensity over time among a plurality of edges present in the target image.

The processor may be configured to generate an edge image by extracting only the target edges from the target image and determine whether the electrode sheet is present in the supply region in a manner in which a variance in pixel intensity of each of the plurality of pixels constituting the generated edge image is calculated.

The processor may be configured to generate a binarized image by binarizing the plurality of pixels on the basis of a value difference between the pixel intensity of each of the plurality of pixels constituting the edge image and a defined (e.g., predefined) reference intensity, calculate an angle formed between the binarized target edge corresponding to the target edge present in the binarized image and a reference axis of the coordinate system of the binarized image, rotate the edge image based on the calculated angle, and determine whether the electrode sheet is present in the supply region in a manner in which a variance in pixel intensity of each of the plurality of pixels constituting the rotated edge image is calculated.

The processor may be configured to calculate a plurality of variances in pixel intensity for each column of the rotated edge image and, if a maximum value of the plurality of variance is greater than a defined (e.g., predefined) reference variance, determine that the electrode sheet is present in the supply region.

The variance in pixel intensity may be a difference between a calculated value of intensities of pixels constituting a first column of the rotated edge image and a calculated value of intensities of pixels constituting a second column of the rotated edge image, the first and second columns may be adjacent columns on the rotated edge image, and the calculated value may be a sum value or an average value.

The processor may be configured to independently perform operations of detecting first and second electrode sheets, and if it is determined that the electrode sheet is present in the supply region as a result of at least one of the operations of detecting the first and second electrode sheets, the processor may determine that the electrode sheet is present in the supply region, the detecting a first electrode sheet may be include determining whether the electrode sheet is present in the supply region in a manner in which the number of valid pixels with the pixel intensity that is greater than or equal to a defined (e.g., predefined) reference intensity is determined among the plurality of pixels constituting the target image, and the detecting the second electrode sheet may include determining whether the electrode sheet is present in the supply region on the basis of a pixel intensity of the target edge determined according to a target edge determination condition defined (e.g., predefined) by considering a variance in pixel intensity over time among a plurality of edges present in the target image.

The apparatus for detecting an electrode sheet may further include a supply member, or supplier, configured to supply the electrode sheet to the supply region, and if it is determined that the electrode sheet is present in the supply region, the processor may stop an operation of the supply member to prevent the electrode sheet from being supplied to the supply region.

The processor may be configured to generate the target image by cropping a region corresponding to a defined (e.g., predefined) region of interest (ROI) in a raw image generated by the sensing member if the sensing member detects the reflected light.

According to one or more embodiments of the present invention, an apparatus for transporting an electrode sheet includes a transport conveyor including a supply region for receiving an electrode sheet and configured to transport the electrode sheet, a supply member, or supplier, configured to supply the electrode sheet to the supply region, a lighting member configured to emit light to the supply region, a sensing member, or sensor, configured to detect reflected light formed by the light emitted from the lighting member and reflected from the supply region, and a control member, or controller, configured to analyze a target image of the supply region generated on the basis of a result of the sensing member detecting the reflected light, determine whether the electrode sheet is present in the supply region, and control an operation of the supply member according to a result of the determination.

According to one or more embodiments of the present invention, a method of detecting an electrode sheet includes acquiring, by a processor, a target image of a supply region while light from a lighting member is emitted to a supply region provided in a transport conveyor, wherein the transport conveyor includes the supply region for receiving the electrode sheet and transports the electrode sheet, a sensing member, or sensor, detects reflected light formed by the light emitted from the lighting member and reflected from the supply region, and the target image is generated on the basis of a result of the sensing member detecting the reflected light; analyzing, by the processor, the target image; and determining, by the processor, whether the electrode sheet is present on the basis of an analysis result of the target image.

### BRIEF DESCRIPTION OF THE DRAWINGS

The following drawings attached to this specification illustrate some embodiments of the present disclosure, and further illustrate aspects and features of the present disclosure together with the detailed description of the present disclosure. However, the present disclosure should not be construed as being limited to the drawings, in which:

FIG. 1 is a schematic plan view showing a configuration of an electrode sheet transporting apparatus according to an embodiment of the present disclosure;

FIG. 2 is a schematic side view showing the configuration of the electrode sheet transporting apparatus of FIG. 1;

FIG. 3 is a schematic perspective view showing a configuration of a lighting member according to an embodiment of the present disclosure;

FIG. 4 is a schematic side view showing the configuration of the lighting member of FIG. 3;

FIG. 5 is a schematic perspective view showing a configuration of a sensing member according to an embodiment of the present disclosure;

FIG. 6 is a schematic side view showing the configuration of the sensing member of FIG. 5;

FIGS. 7 and 8 are views showing a modified example of the sensing member shown in FIGS. 5 and 6;

FIG. 9 is a schematic block diagram showing a configuration of a controller according to an embodiment of the present disclosure;

FIGS. 10 to 13 are schematic views showing an operation process of the electrode sheet transporting apparatus according to an embodiment of the present disclosure;

FIG. 14 is a schematic view showing a configuration of an electrode sheet transporting apparatus according to another embodiment of the present disclosure;

FIG. 15 is a schematic block diagram showing the configuration of the electrode sheet transporting apparatus of FIG. 14;

FIG. 16 is a schematic perspective view showing a configuration of a lighting member according to an embodiment of the present disclosure;

FIG. 17 is a schematic view showing a configuration of a camera according to an embodiment of the present disclosure;

FIGS. 18 to 21 are schematic views showing an operation process of the electrode sheet transporting apparatus according to an embodiment of the present disclosure;

FIG. 22 is a schematic view showing a configuration of an electrode sheet transporting apparatus according to another embodiment of the present disclosure;

FIG. 23 is a schematic perspective view showing a configuration of a lighting member according to an embodiment of the present disclosure;

FIGS. 24 and 25 are schematic views showing an operation process of the lighting member of FIG. 23;

FIG. 26 is a schematic view showing a configuration of a lighting member according to another embodiment of the present disclosure;

FIG. 27 is a schematic view showing an operation of the lighting member of FIG. 26;

FIG. 28 is a block diagram illustrating an apparatus for detecting an electrode sheet according to an embodiment of the present invention;

FIGS. 29 to 42 are diagrams for describing a process for determining whether an electrode sheet is present in a supply region of a transport conveyor by the apparatus for detecting an electrode sheet according to an embodiment of the present invention; and

FIGS. 43 to 46 are flowcharts illustrating a method of detecting an electrode sheet according to an embodiment of the present invention.

### DETAILED DESCRIPTION

Herein, some embodiments of the present disclosure will be described, in further detail, with reference to the accompanying drawings. However, the terms or words used in this specification and claims are not to be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part, or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

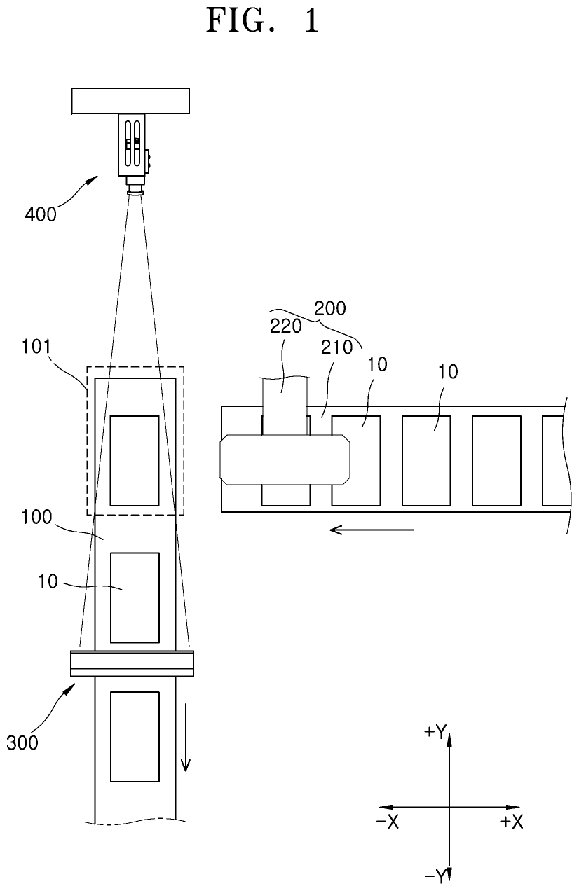

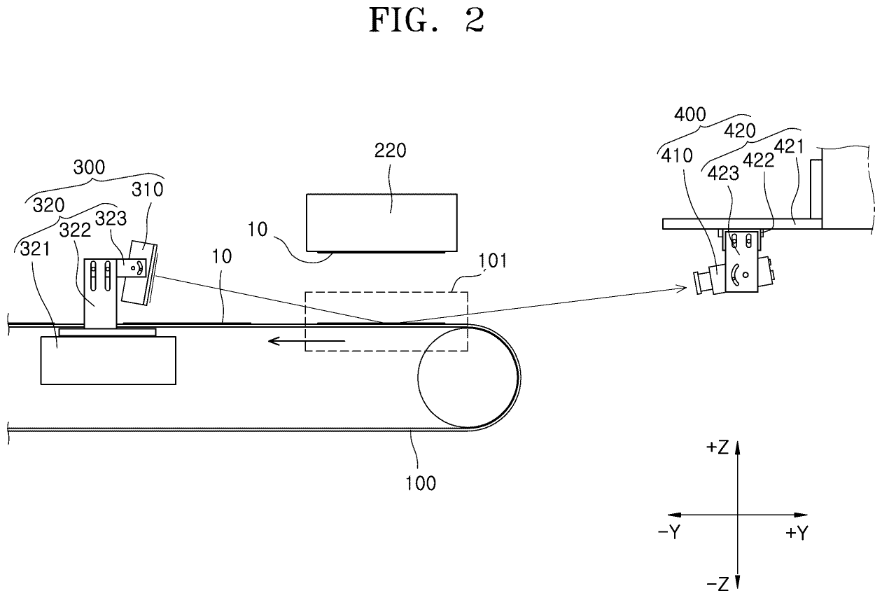

FIG. 1 is a schematic plan view showing a configuration of an electrode sheet transporting apparatus according to an embodiment of the present disclosure; and FIG. 2 is a schematic side view showing the configuration of the electrode sheet transporting apparatus of FIG. 1.

Referring to FIGS. 1 and 2, the electrode sheet transporting apparatus according to the present embodiment may include a transporting conveyor 100, a supply member, or supplier, 200, a lighting member 300, and a sensing member, or sensor, 400.

As described below, for example, a first direction may be a-Y-axis direction based on FIGS. 1 and 2, a second direction may be a-X-axis direction based on FIGS. 1 and 2, and a third direction may be a-Z-axis direction based on FIGS. 1 and 2.

An electrode sheet 10 may function as a unit structure of an electrode assembly that performs charging and discharging operations of a secondary battery. The electrode sheet 10 according to an embodiment may have a plate shape in which a metal foil, such as aluminum or an aluminum alloy, is coated with an active material layer. The electrode sheet 10 may function as a negative electrode sheet or a positive electrode sheet of the secondary battery depending on a type of active material included in the active material layer. Although FIG. 1 shows an example of a quadrangular electrode sheet 10, a shape of the electrode sheet 10 is not limited thereto and may be varied to any suitable shape, such as a circular shape, an oval shape, etc.

The transporting conveyor 100 may transport the electrode sheet 10 in the first direction.

The transporting conveyor 100 according to an embodiment may be a belt conveyor type in which a belt moves in a caterpillar manner by the rotation of a drive pulley. In an embodiment, a belt of the transporting conveyor 100 may be made of a material having a lower reflectivity than the electrode sheet 10. However, the transporting conveyor 100 is not limited thereto and may be varied to any type of transporting unit capable of transporting the electrode sheet 10 in the first direction, such as a roller conveyor, a chain conveyor, etc.

A longitudinal direction of the transporting conveyor 100 may be disposed in the first direction. A plurality of electrode sheets 10 may be arranged on the transporting conveyor 100 at intervals (e.g., set intervals) in the first direction. The transporting conveyor 100 may continuously transport the plurality of electrode sheets 10 in the first direction by the movement of the belt.

The transporting conveyor 100 may include a supply area 101 that receives the electrode sheet 10 from the supply member 200.

The supply area 101 according to an embodiment may be an area of an end portion of the transporting conveyor 100 at which the transport of the electrode sheet 10 starts among the entire area of the transporting conveyor 100. The electrode sheet 10 supplied from the supply member 200 may be seated on the supply area 101. The electrode sheet 10 seated on the supply area 101 may be transported in the first direction by the operation of the transporting conveyor 100.

The supply member 200 may supply the electrode sheet to the supply area 101 of the transporting conveyor 100.

The supply member 200 according to an embodiment may include a supply conveyor 210 and a conveying unit 220.

The supply conveyor 210 may transport the electrode sheet 10 in the second direction.

The supply conveyor 210 according to an embodiment may be a belt conveyor type in which a belt moves in a caterpillar manner by the rotation of a drive pulley. However, the supply conveyor 210 is not limited thereto and may be varied to any type of transporting unit capable of transporting the electrode sheet 10 in the second direction, such as a roller conveyor, a chain conveyor, etc.

The supply conveyor 210 may be disposed to intersect the transporting conveyor 100. A longitudinal direction of the supply conveyor 210 may be disposed in the second direction. A plurality of electrode sheets 10 may be arranged on the supply conveyor 210 at intervals (e.g., set intervals) in the second direction. In an embodiment, the supply conveyor 210 may continuously transport the plurality of electrode sheets 10 in the second direction by the movement of the belt.

An end portion of the supply conveyor 210 may be disposed to face the supply area 101 of the transporting conveyor 100 in the second direction. The end portion of the supply conveyor 210 may be spaced a distance (e.g., a predetermined distance) from the supply area 101 of the transporting conveyor 100 in a direction opposite to the second direction.

The conveying unit 220 may convey the electrode sheet 10 transported by the supply conveyor 210 to the supply area 101.

The conveying unit 220 according to an embodiment may be disposed at a position spaced apart from the supply conveyor 210 and the transporting conveyor 100 in a direction opposite to the third direction, for example, above the supply conveyor 210 and the transporting conveyor 100.

In an embodiment, the conveying unit 220 may reciprocate between the supply conveyor 210 and the transporting conveyor 100. For example, the conveying unit 220 may repeatedly perform an operation of moving in the second direction from the supply conveyor 210 to the transporting conveyor 100 and then moving in the direction opposite to the second direction from the transporting conveyor 100 to the supply conveyor 210.

The conveying unit 220 may move in the third direction and in the direction opposite to the third direction on the supply conveyor 210 and pick up the electrode sheet 10. In an embodiment, for example, the conveying unit 220 may include an adsorber for adsorbing the electrode sheet 10 by a vacuum pressure or a gripper for gripping the electrode sheet 10 by a gripping operation.

The conveying unit 220 may move toward the electrode sheet 10 in the third direction on the supply conveyor 210 and come into contact with the electrode sheet 10. In an embodiment, the electrode sheet 10 may be fixed to the conveying unit 220 by an adsorbing or gripping method. Then, the conveying unit 220 may move from the supply conveyor 210 in the direction opposite to the third direction and move toward the transporting conveyor 100 in the second direction.

After the conveying unit 220 moves from the supply conveyor 210 in the second direction, the conveying unit 220 may move in the third direction and in the direction opposite to the third direction on the transporting conveyor 100 and allow the electrode sheet 10 to be seated on the supply area 101.

For example, the conveying unit 220 may move toward the supply area 101 in the third direction on the transporting conveyor 100 and allow the electrode sheet 10 to be seated on the supply area 101 by a method of releasing the adsorption of the electrode sheet 10 by the adsorber or releasing the grip of the electrode sheet 10 by the gripper. Then, the conveying unit 220 may move from the transporting conveyor 100 in the direction opposite to the third direction and move toward the supply conveyor 210 in the direction opposite to the second direction.

The lighting member 300 may radiate light to the supply area 101.

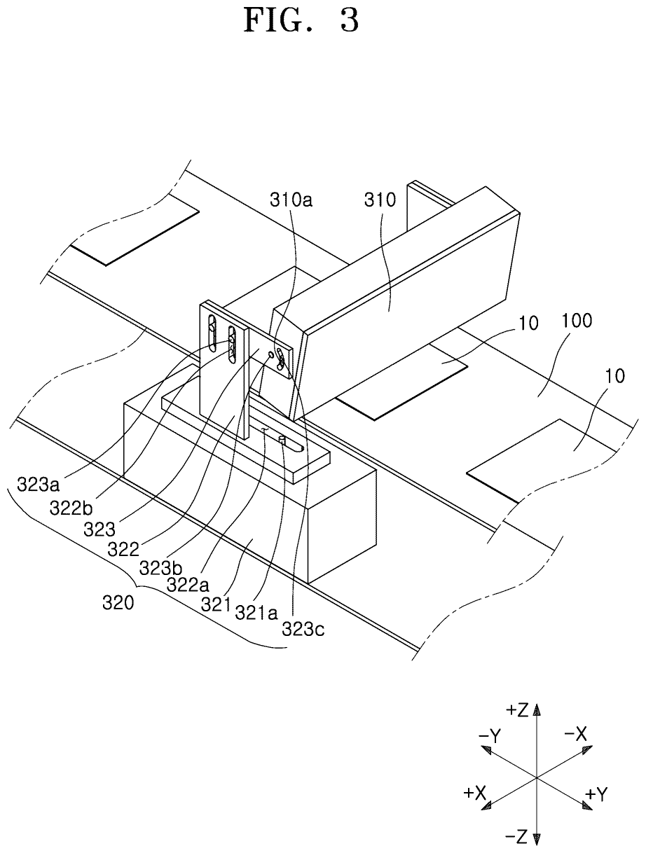

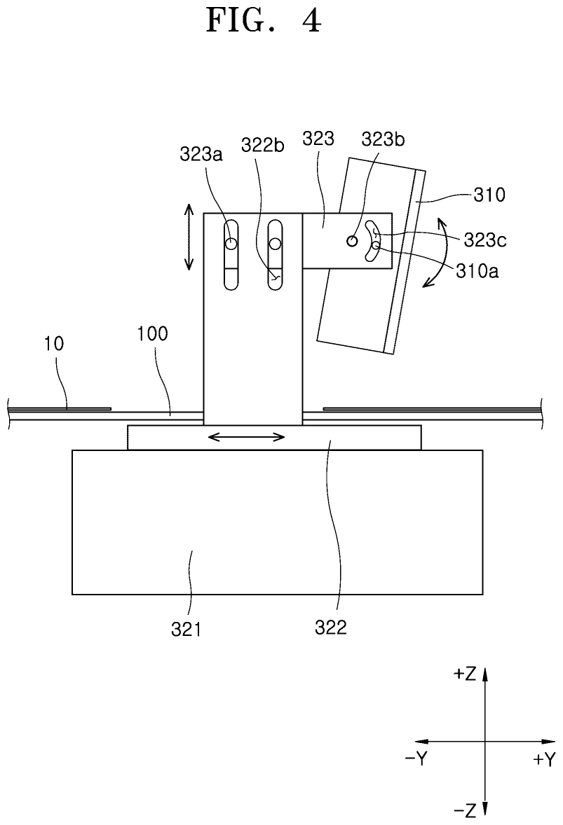

FIG. 3 is a schematic perspective view showing a configuration of a lighting member according to an embodiment of the present disclosure; and FIG. 4 is a schematic side view showing the configuration of the lighting member of FIG. 3.

Referring to FIGS. 1 to 4, the lighting member 300 may include a light source 310 and a lighting bracket 320.

The light source 310 may be spaced apart from the transporting conveyor 100 and may radiate light toward the supply area 101.

The light source 310 according to an embodiment may be disposed at an upper side of the transporting conveyor 100. The light source 310 may be disposed at a position spaced by a distance (e.g., a predetermined) distance from the supply area 101 in the first direction.

In an embodiment, the light source 310 may include a case having a generally rectangular box shape and any suitable type of light-emitting device, such as a light emitting diode (LED), a fluorescent lamp, an incandescent lamp, a halogen lamp, or a laser, disposed inside the case. Light generated from the light-emitting device may be radiated to the supply area 101 through a surface of the light source 310 disposed to face the supply area 101.

In an embodiment, a width of the light source 310 in the second direction may be greater than a width of the transporting conveyor 100 in the second direction. Therefore, the light source 310 may radiate light over the overall width of the supply area 101.

The lighting bracket 320 may support the light source 310.

The lighting bracket 320 according to an embodiment may include a first lighting bracket 321, a second lighting bracket 322, and a third lighting bracket 323.

The first lighting bracket 321 may form an exterior of a side of the lighting bracket 320 and support the second lighting bracket 322.

In an embodiment, a pair of first lighting brackets 321 may be provided. The pair of first lighting brackets 321 may be disposed to face each other in the second direction with the transporting conveyor 100 interposed therebetween. The first lighting bracket 321 may be fixed to a frame of the transporting conveyor 100 or may be fixed on the ground, for example. However, a shape of the first lighting bracket 321 is not limited to the shapes shown in FIGS. 3 and 4 and may be varied within the technical spirit of the shape capable of supporting the second lighting bracket 322 that will be described below.

The second lighting bracket 322 may be connected to the first lighting bracket 321 to support the third lighting bracket 323.

The second lighting bracket 322 according to an embodiment may have a form in which a lower side is seated on the first lighting bracket 321 and an upper side extends upward from the first lighting bracket 321, that is, in the direction opposite to the third direction. A height of an upper end portion of the second lighting bracket 322 may be greater than a height of the electrode sheet 10 seated on the transporting conveyor 100. Therefore, the second lighting bracket 322 can prevent or substantially prevent interference between the light source 310 and the electrode sheet 10.

In an embodiment, a pair of second lighting brackets 322 may be provided. The pair of second lighting brackets 322 may be individually connected to different, or respective, first lighting brackets 321.

The second lighting bracket 322 may be connected to the first lighting bracket 321 to be movable in the first direction and in a direction opposite to the first direction. Therefore, the second lighting bracket 322 may adjust a space between the light source 310 and the sensing member 400 according to a size of the electrode sheet 10, a position of the sensing member 400, and the like, which will be described below.

For example, the lighting member 300 may further include a first lighting rail 322a passing through the second lighting bracket 322. The first lighting rail 322a according to an embodiment may pass through a lower portion of the second lighting bracket 322 seated on the first lighting bracket 321 in the third direction. A longitudinal direction of the first lighting rail 322a may extend in the first direction.

The lighting member 300 may further include a first lighting pin 321a protruding from the first lighting bracket 321 and inserted into the first lighting rail 322a. The first lighting pin 321a according to an embodiment may have a rod shape that extends from an upper surface of the first lighting bracket 321 on which the second lighting bracket 322 is seated in the direction opposite to the third direction.

The second lighting bracket 322 may slide in the first direction or in the direction opposite to the first direction by an external force applied from the outside in a state in which the first lighting pin 321a is inserted into the first lighting rail 322a.

However, a connection relationship between the first lighting bracket 321 and the second lighting bracket 322 is not limited to the above-described shape and may be changed in design in various ways within the range of a structure in which the first lighting bracket 321 may move relatively with respect to the second lighting bracket 322 in the first direction.

The third lighting bracket 323 may extend from the second lighting bracket 322 and support the light source 310.

The third lighting bracket 323 according to an embodiment may have a plate shape that extends from the upper end portion of the second lighting bracket 322 in the direction opposite to the first direction. An end portion of the third lighting bracket 323 may be disposed to face the upper end portion of the second lighting bracket 322 in the second direction. Another end portion of the third lighting bracket 323 may protrude outward from the second lighting bracket 322 and may be disposed to face a side surface of the light source 310 in the second direction.

In an embodiment, a pair of third lighting brackets 323 may be provided. The pair of third lighting brackets 323 may be individually connected to different, or respective, second lighting brackets 322.

The third lighting bracket 323 may be connected to the second lighting bracket 322 to be movable in the third direction or in the direction opposite to the third direction. Therefore, the third lighting bracket 323 may adjust the height of the light source 310 in response to a difference in height between the conveying unit 220 and the supply area 101 when the electrode sheet 10 is supplied.

For example, the lighting member 300 may further include a second lighting rail 322b passing through the second lighting bracket 322. The second lighting rail 322b according to an embodiment may pass through an upper end portion of the second lighting bracket 322 facing the third lighting bracket 323 in the second direction. A longitudinal direction of the second lighting rail 322b may extend in the third direction.

The lighting member 300 may further include a second lighting pin 323a protruding from the third lighting bracket 323 and inserted into the second lighting rail 322b. The second lighting pin 323a according to an embodiment may have a rod shape that extends from an end portion of the third lighting bracket 323 facing the second lighting bracket 322 in the direction parallel to the second direction.

The third lighting bracket 323 may slide in the third direction or in the direction opposite to the third direction by an external force applied from the outside in a state in which the second lighting pin 323a is inserted into the second lighting rail 322b.

However, a connection relationship between the second lighting bracket 322 and the third lighting bracket 323 is not limited to the above-described shape and may be varied within the range of a structure in which the third lighting bracket 323 may move relatively with respect to the second lighting bracket 322 in the third direction.

The light source 310 may be connected to the third lighting bracket 323 to be rotatable with respect to the second direction. Therefore, an angle of light radiated from the light source 310 may be adjusted according to the position of the sensing member 400, the height of the electrode sheet 10, or the like.

For example, the lighting member 300 may further include a light source shaft 323b for rotatably supporting the light source 310 with respect to the third lighting bracket 323. The light source shaft 323b according to an embodiment may have a pin shape that passes through the another end portion of the third lighting bracket 323 facing the light source 310 and the side surface of the light source 310. A longitudinal direction of the light source shaft 323b may be disposed in the second direction. The light source 310 may be rotated about the light source shaft 323b clockwise or counterclockwise by an external force applied from the outside.

The lighting member 300 may further include a third lighting rail 323c and a third lighting pin 310a that guide the rotation of the light source 310 with respect to the third lighting bracket 323.

The third lighting rail 323c according to an embodiment may pass through the another end portion of the third lighting bracket 323 facing the side surface of the light source 310 in the second direction. In an embodiment, the third lighting rail 323c may have an arc shape that extends in a circumferential direction based on the light source shaft 323b.

The third lighting pin 310a according to an embodiment may have a rod shape that extends from the side surface of the light source 310 facing the third lighting bracket 323 in the direction parallel to the second direction. The third lighting pin 310a may be inserted into the third lighting rail 323c. As the light source 310 rotates about the light source shaft 323b, the third lighting pin 310a may slide along the third lighting rail 323c.

However, a connection relationship between the third lighting bracket 323 and the light source 310 is not limited to the above-described shape and may be varied within the range of a structure in which the light source 310 is connected to the third lighting bracket 323 to be rotatable with respect to the second direction.

The lighting member 300 according to an embodiment may further include an actuator, such as a motor, and a power transmission unit, such as a reducer, to move or rotate the light source 310, the second lighting bracket 322, and the third lighting bracket 323 by their own driving force.

The sensing member 400 may be disposed to face the lighting member 300. The sensing member 400 may detect the presence or absence of the electrode sheet 10 on the supply area 101 based on the light radiated from the lighting member 300.

For example, the sensing member 400 may detect light reflected from the electrode sheet 10 positioned in the supply area 101. In an embodiment, the electrode sheet 10 is made of a metallic material, and an amount of light reflected from the electrode sheet 10 may be greater than an amount of light reflected from the belt of the transporting conveyor 100. The sensing member 400 may detect the presence or absence of the electrode sheet 10 on the supply area 101 through a difference in reflectivity between the electrode sheet 10 and the transporting conveyor 100.

The sensing member 400 and the lighting member 300 may be spaced apart from each other in the first direction. For example, the sensing member 400 may be disposed at a position spaced by a distance (e.g., a predetermined distance) from the lighting member 300 in the direction opposite to the first direction. Therefore, the conveying unit 220 moving in the second direction or in the direction opposite to the second direction between the supply conveyor 210 and the transporting conveyor 100 may pass through a space between the lighting member 300 and the sensing member 400 without interfering with the lighting member 300 and the sensing member 400.

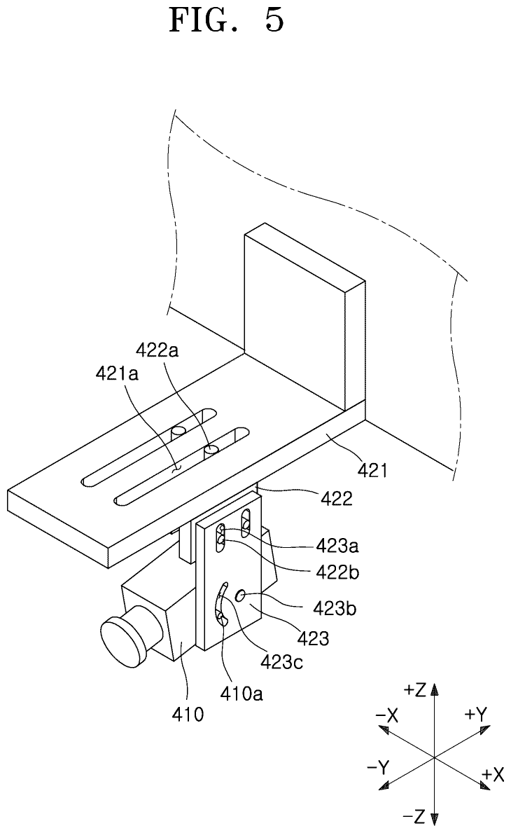

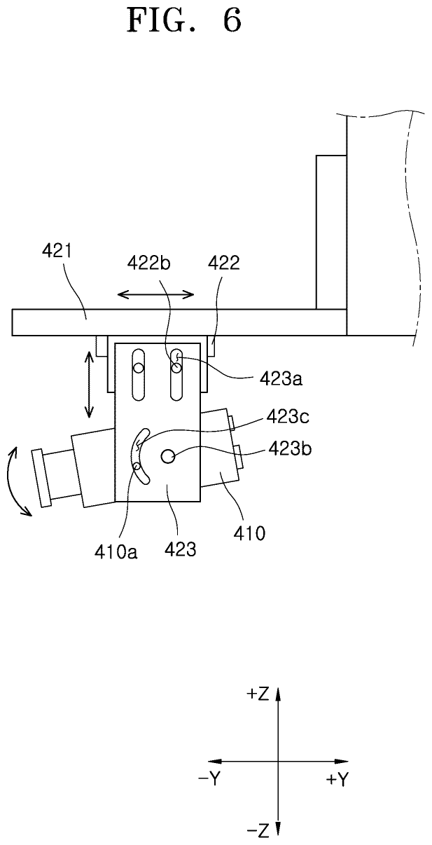

FIG. 5 is a schematic perspective view showing a configuration of a sensing member according to an embodiment of the present disclosure; and FIG. 6 is a schematic side view showing the configuration of the sensing member of FIG. 5.

Referring to FIGS. 5 and 6, the sensing member 400 according to an embodiment may include a camera 410 and a camera bracket 420.

The camera 410 may acquire an optical image of the supply area 101.

The camera 410 according to an embodiment may be any type of optical device capable of detecting the light reflected from the electrode sheet 10 positioned in the supply area 101, such as a mono camera, a color camera, or a vision sensor.

The camera 410 may be disposed to face the lighting member 300, and, in an embodiment, the light source 310 in the first direction. The camera 410 may be disposed to face the light source 310 in the first direction with the supply area 101 interposed therebetween. The camera 410 may be disposed at a position spaced by a distance (e.g., a predetermined distance) from the lighting member 300 in the direction opposite to the first direction. The camera 410 may be disposed above the transporting conveyor 100. The camera 410 may be disposed so as not to face the transporting conveyor 100 in the third direction or may be disposed to face the transporting conveyor 100 in the third direction. The camera 410 may be disposed such that a lens faces the supply area 101 and the light reflected from the electrode sheet 10 is incident on the supply area 101.

The camera bracket 420 may support the camera 410.

The camera bracket 420 according to an embodiment may include a first camera bracket 421, a second camera bracket 422, and a third camera bracket 423.

The first camera bracket 421 may form an exterior of a side of the camera bracket 420 and support the second camera bracket 422.

The first camera bracket 421 according to an embodiment may be spaced apart from the transporting conveyor 100. The first camera bracket 421 may be disposed above the transporting conveyor 100. The first camera bracket 421 may be fixed to a wall, ceiling, or separate frame and fixedly positioned above the transporting conveyor 100. The first camera bracket 421 may be disposed so as not to face the transporting conveyor 100 in the third direction or may be disposed to face the transporting conveyor 100 in the third direction. However, a shape of the first camera bracket 421 is not limited to the shapes shown in FIGS. 5 and 6 and may be varied within the technical spirit of the shape capable of supporting the second camera bracket 422 that will be described below.

The second camera bracket 422 may be connected to the first camera bracket 421 to support the third camera bracket 423.

The second camera bracket 422 according to an embodiment may be disposed under the first camera bracket 421. However, a shape of the second camera bracket 422 is not limited to the shapes shown in FIGS. 5 and 6 and may be varied within the technical spirit of the shape capable of supporting the third camera bracket 423 that will be described below.

The second camera bracket 422 may be connected to the first camera bracket 421 to be movable in the first direction and in the direction opposite to the first direction. Therefore, the second camera bracket 422 may adjust a space between the light source 310 and the camera 410 according to the size of the electrode sheet 10, the position of the lighting member 300, and the like.

In an embodiment, for example, the sensing member 400 may further include a first camera rail 421a passing through the first camera bracket 421. The first camera rail 421a according to an embodiment may pass through the first camera bracket 421 in the third direction. A longitudinal direction of the first camera rail 421a may extend in the first direction.

The lighting member 300 may further include a first camera pin 422a protruding from the second camera bracket 422 and inserted into the first camera rail 421a. The first camera pin 422a according to an embodiment may have a rod shape that extends from an upper surface of the second camera bracket 422 facing the first camera bracket 421 in the direction opposite to the third direction.

The second camera bracket 422 may slide in the first direction or in the direction opposite to the first direction by an external force applied from the outside in a state in which the first camera pin 422a is inserted into the first camera rail 421a.

However, a connection relationship between the first camera bracket 421 and the second camera bracket 422 is not limited to the above-described shape and may be varied within the range of a structure in which the second camera bracket 422 may move relatively with respect to the first camera bracket 421 in the first direction.

The third camera bracket 423 may extend from the second camera bracket 422 and support the camera 410.

The third camera bracket 423 according to an embodiment may have a plate shape that extends from a lower end portion of the second camera bracket 422 in the third direction. An upper end portion of the third camera bracket 423 may be disposed to face the lower end portion of the second camera bracket 422 in the second direction. A lower end portion of the third camera bracket 423 may protrude outward from the second camera bracket 422 and may be disposed to face a side surface of the camera 410 in the second direction.

The third camera bracket 423 may be connected to the second camera bracket 422 to be movable in the third direction and in the direction opposite to the third direction. Therefore, the third camera bracket 423 may adjust the height of the camera 410 in response to a difference in height between the conveying unit 220 and the supply area 101 when the electrode sheet 10 is supplied.

For example, the sensing member 400 may further include a second camera rail 423a passing through the third camera bracket 423. The second camera rail 423a according to an embodiment may pass through the upper end portion of the third camera bracket 423 facing the lower end portion of the second camera bracket 422 in the second direction. A longitudinal direction of the second camera rail 423a may extend in the third direction.

The sensing member 400 may further include a second camera pin 422b protruding from the second camera bracket 422 and inserted into the second camera rail 423a. The second camera pin 422b according to an embodiment may have a rod shape that extends from the lower end portion of the second camera bracket 422 facing the upper end portion of the third camera bracket 423 in the direction parallel to the second direction.

The third camera bracket 423 may slide in the third direction or in the direction opposite to the third direction by an external force applied from the outside in a state in which the second camera pin 422b is inserted into the second camera rail 423a.

However, a connection relationship between the second camera bracket 422 and the third camera bracket 423 is not limited to the above-described shape and may be varied within the range of a structure in which the third camera bracket 423 may move relatively with respect to the second camera bracket 422 in the third direction.

The camera 410 may be connected to the third camera bracket 423 to be rotatable with respect to the second direction. Therefore, a capturing angle of the camera 410 may be adjusted according to an angle of light radiated from the light source 310, the height of the electrode sheet 10, or the like.

For example, the sensing member 400 may further include a camera shaft 423b for rotatably supporting the camera 410 with respect to the third camera bracket 423. The camera shaft 423b according to an embodiment may have a pin shape that passes through another end portion of the third camera bracket 423 facing the camera 410 and a side surface of the camera 410. A longitudinal direction of the camera shaft 423b may be disposed in the second direction. The camera 410 may be rotated about the camera shaft 423b clockwise or counterclockwise by an external force applied from the outside.

The sensing member 400 may further include a third camera rail 423c and a third camera pin 410a that guide the rotation of the camera 410 with respect to the third camera bracket 423.

The third camera rail 423c according to the present embodiment may pass through the other end portion of the third camera bracket 423 facing the side surface of the camera 410 in the second direction. In an embodiment, the third camera rail 423c may have an arc shape that extends in a circumferential direction based on the camera shaft 423b.

The third camera pin 410a according to an embodiment may have a rod shape that extends from the side surface of the camera 410 facing the third camera bracket 423 in the direction parallel to the second direction. The third camera pin 410a may be inserted into the third camera rail 423c. As the camera 410 rotates about the camera shaft 423b, the third camera pin 410a may slide along the third camera rail 423c.

However, a connection relationship between the third camera bracket 423 and the camera 410 is not limited to the above-described shape and may be varied within the range of a structure in which the camera 410 is connected to the third camera bracket 423 to be rotatable with respect to the second direction.

The sensing member 400 according to an embodiment may further include an actuator, such as a motor, and a power transmission unit, such as a reducer, to move or rotate the camera 410, the second camera bracket 422, and the third camera bracket 423 by their own driving force.

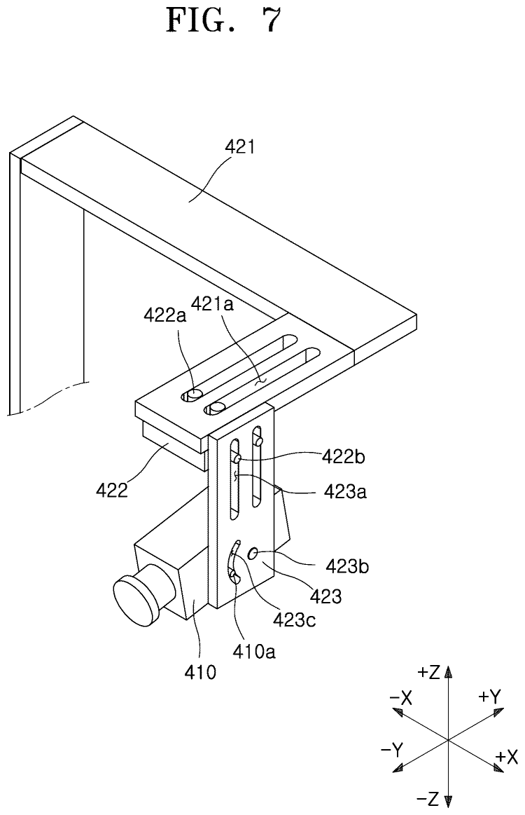

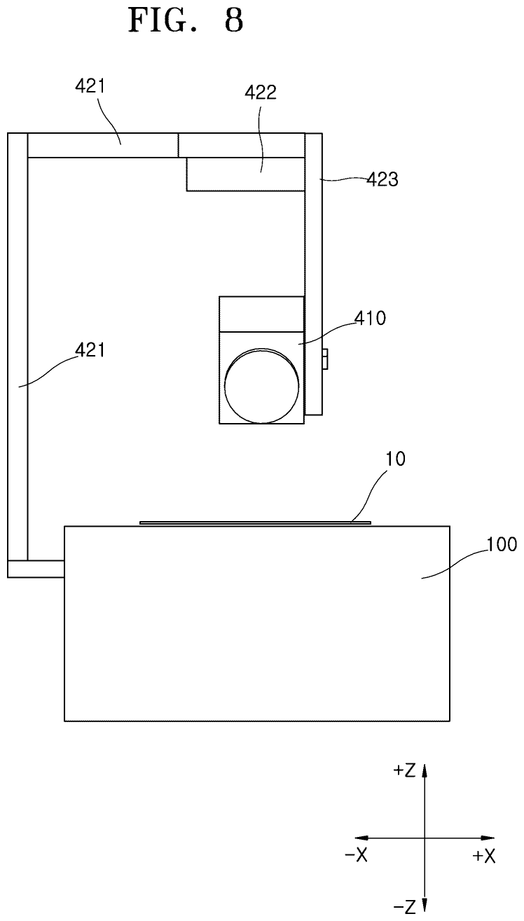

FIGS. 7 and 8 are views showing a modified example of the sensing member shown in FIGS. 5 and 6.

Referring to FIGS. 7 and 8, the first camera bracket 421 may be connected to the transporting conveyor 100. In an embodiment, a lower end portion of the first camera bracket 421 may be fixed to the frame of the transporting conveyor 100. An upper end portion of the first camera bracket 421 may extend upward from the transporting conveyor 100. The upper end portion of the first camera bracket 421 may support the second camera bracket 422 at a position spaced apart from the lighting member 300 in the direction opposite to the first direction.

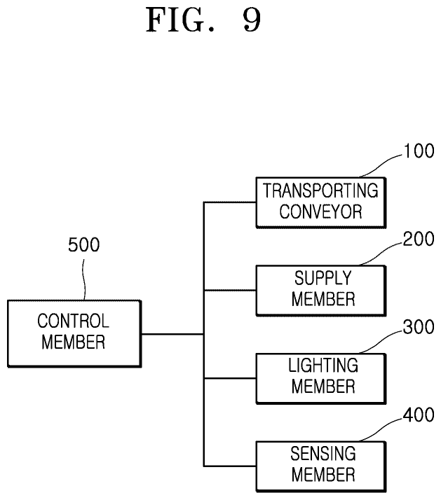

FIG. 9 is a schematic block diagram showing a configuration of a controller according to an embodiment of the present disclosure.

Referring to FIG. 9, the electrode sheet transporting apparatus according to an embodiment may further include a control member, or controller, 500.

The control member 500 may control an overall operation of the transporting conveyor 100, the supply member 200, the lighting member 300, and the sensing member 400.

The control member 500 may control the supply operation of the supply member 200 based on information detected from the sensing member 400. In an embodiment, the control member 500 may determine the presence or absence of the electrode sheet 10 on the supply area 101 based on the information detected from the sensing member 400. If the control member 500 determines that the electrode sheet 10 is not present on the supply area 101, the control member 500 may operate the supply member 200. If the control member 500 determines that the electrode sheet 10 is present on the supply area 101, the control member 500 may stop the operation of the supply member 200. Therefore, the control member 500 can prevent or substantially prevent two or more electrode sheets 10 from overlapping at a same position on the transporting conveyor 100.

In an embodiment, the control member 500 may control the operation of a drive pulley of the transporting conveyor 100 to adjust a transporting speed of the electrode sheet 10, a transporting direction of the electrode sheet 10, whether the electrode sheet 10 is transported, and the like.

In an embodiment, the control member 500 may control the operations of the actuators of the lighting member 300 and the sensing member 400 to adjust positions, angles, and the like of the light source 310 and the camera 410.

In an embodiment, the control member 500 may include at least one of an electronic control unit (ECU), a central processing unit (CPU), a processor, or a system on chip (SoC), control a plurality of hardware or software components by driving an operating system or an application, and perform various data processing and calculations. The control member 500 may be configured to execute at least one command stored in a memory and store execution result data in the memory. In an embodiment, the control member 500 may include at least one of a radio frequency (RF), a Wi-Fi, a Bluetooth, a Zigbee, and a near field communication (NFC) device that may implement various communication protocols capable of receiving input signals generated from various input devices.

Herein, operation of the electrode sheet transporting apparatus according to an embodiment of the present disclosure will be described.

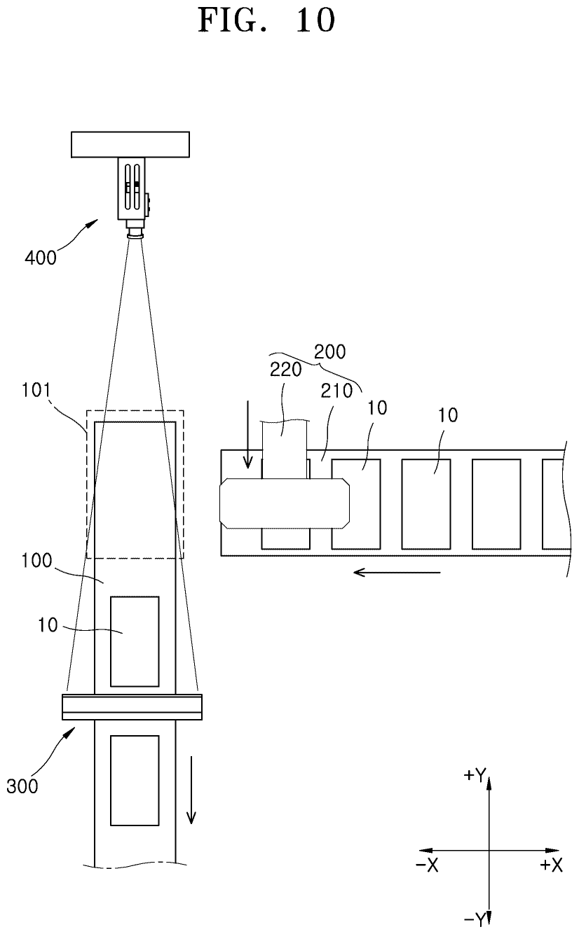

FIGS. 10 to 13 are schematic views showing an operation process of the electrode sheet transporting apparatus according to an embodiment of the present disclosure.

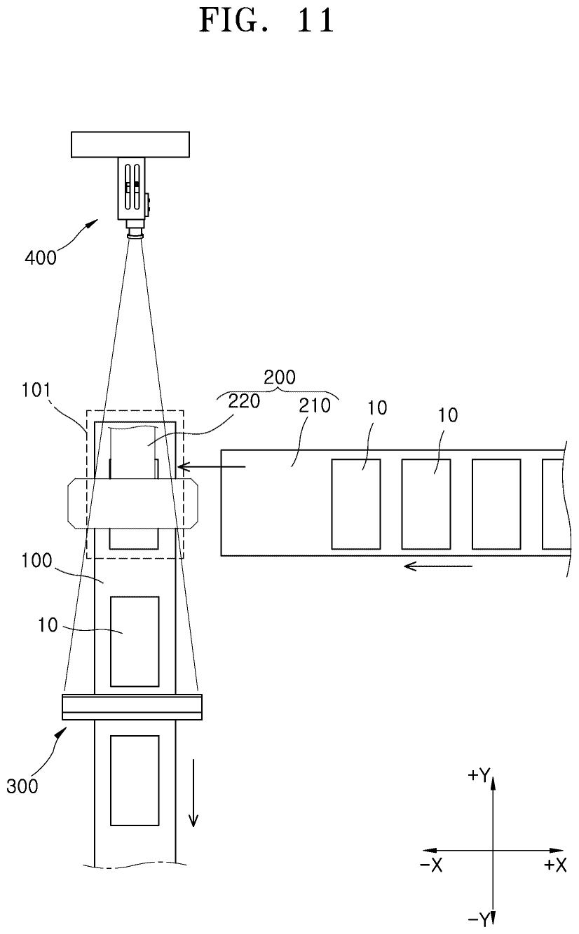

Referring to FIGS. 10 and 11, in a process in which the transporting conveyor 100 transports the electrode sheet 10 in the first direction, the light source 310 radiates light to the supply area 101, and the camera 410 detects light reflected from the supply area 101.

The control member 500 determines whether the electrode sheet 10 is present on the supply area 101 based on information detected from the sensing member 400.

When the transporting conveyor 100 operates, the electrode sheet 10 positioned on the supply area 101 moves from the supply area 101 in the first direction, and the electrode sheet 10 is not present on the supply area 101.

When the electrode sheet 10 is not present on the supply area 101, the light radiated from the light source 310 to the supply area 101 is not reflected from the supply area 101 or is reflected with a same reflectivity over an entire area of the supply area 101.

Therefore, light is not incident on the camera 410 or light of a same brightness is incident on the entire area of the supply area 101, and the control member 500 determines that the electrode sheet 10 is not present on the supply area 101.

Then, the control member 500 operates the supply member 200 such that the electrode sheet 10 is supplied to the supply area 101.

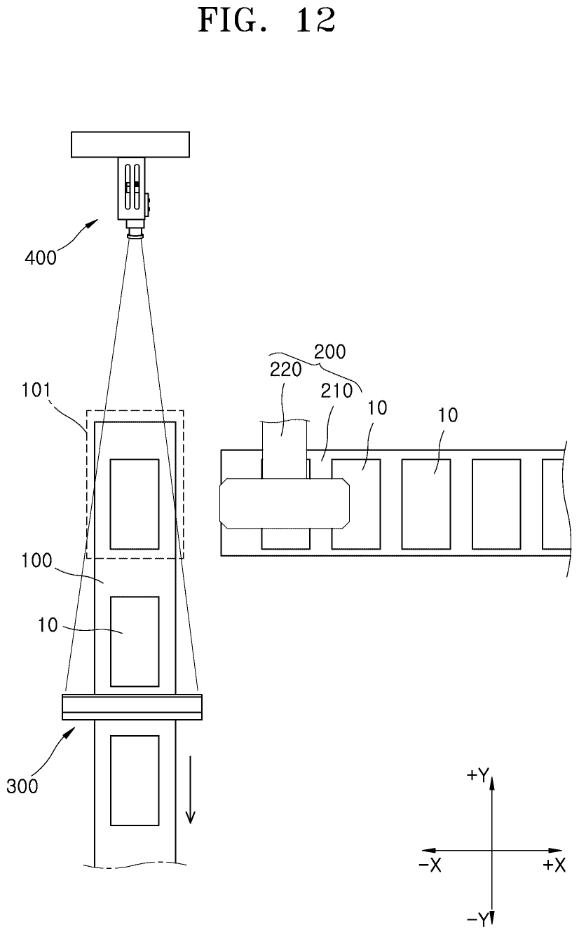

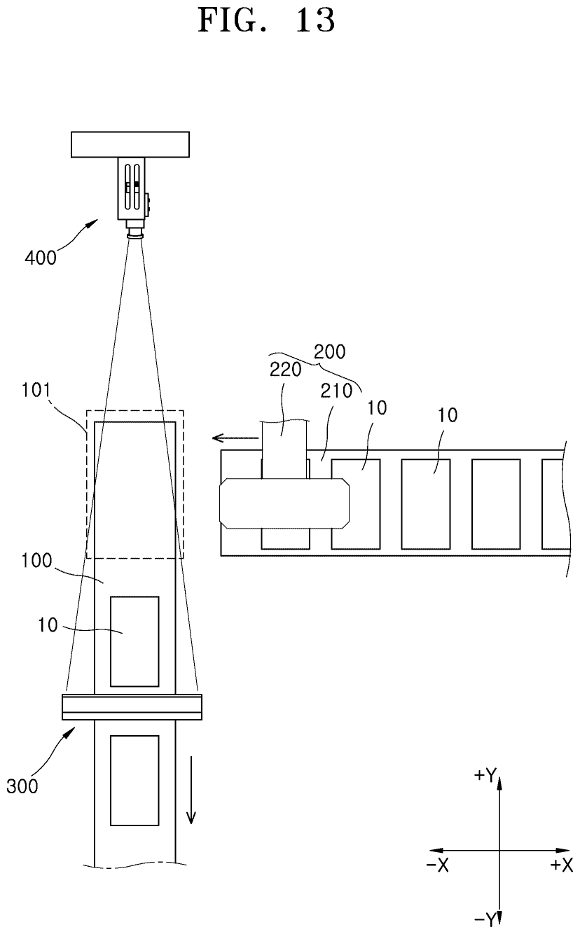

Referring to FIGS. 12 and 13, if an operation error of the transporting conveyor 100 occurs, the electrode sheet 10 positioned on the supply area 101 does not move in the first direction, and the electrode sheet 10 is present on the supply area 101.

In an embodiment, the electrode sheet 10 is made of a material having a higher reflectivity than the belt of the transporting conveyor 100, and the brightness of the light reflected from the electrode sheet 10 is greater than the brightness of the light reflected from the belt of the transporting conveyor 100.

Therefore, light of different brightness is incident on the camera 410 in the area in which the electrode sheet 10 is positioned and in the area in which the electrode sheet 10 is not positioned, and the control member 500 determines that the electrode sheet 10 is present on the supply area 101.

Then, the control member 500 stops the operation of the supply member 200 such that the electrode sheet 10 is not supplied to the supply area 101.

Herein, an electrode sheet transporting apparatus according to another embodiment of the present disclosure will be described.

In describing the electrode sheet transporting apparatus according to the present embodiment, overlapping descriptions of the electrode sheet transporting apparatus according to the previously described embodiment of the present disclosure will be omitted.

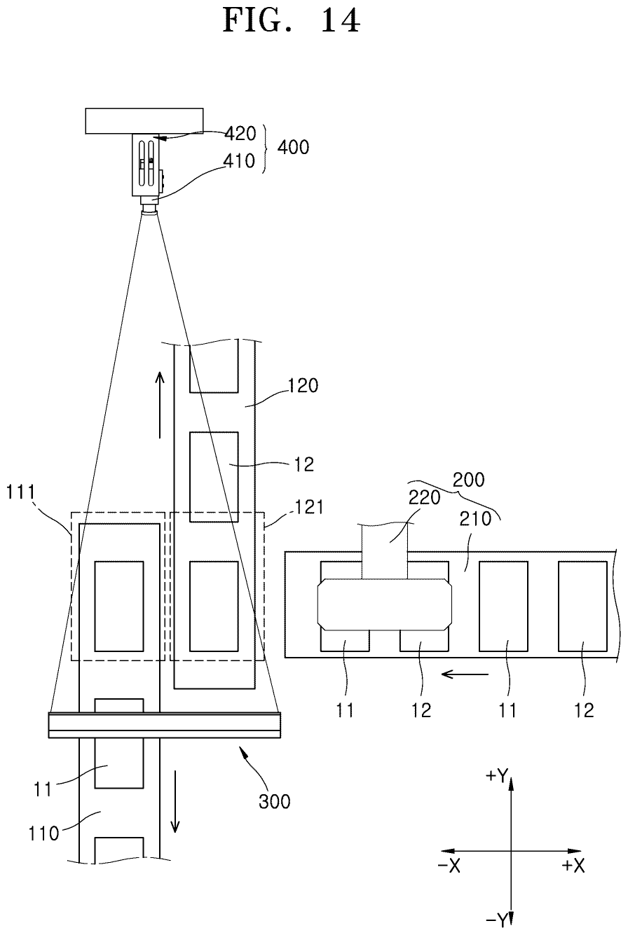

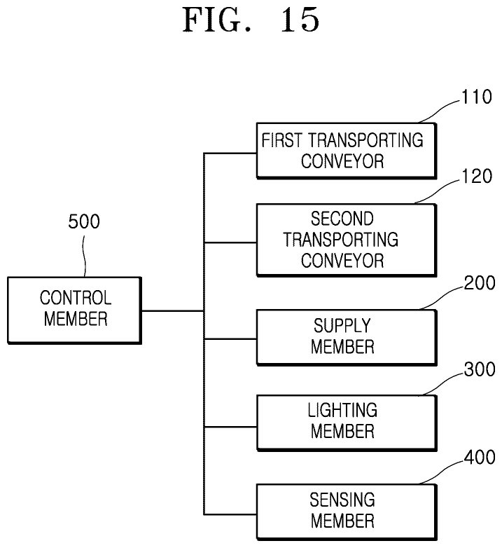

FIG. 14 is a schematic view showing a configuration of an electrode sheet transporting apparatus according to another embodiment of the present disclosure; and FIG. 15 is a schematic block diagram showing the configuration of the electrode sheet transporting apparatus of FIG. 14.

Referring to FIGS. 14 and 15, the electrode sheet transporting apparatus according to the present embodiment may include a first transporting conveyor 110, a second transporting conveyor 120, the supply member 200, the lighting member 300, the sensing member 400, and the control member 500.

The first transporting conveyor 110 and the second transporting conveyor 120 may transport a first electrode sheet 11 and a second electrode sheet 12, respectively.

The first electrode sheet 11 and the second electrode sheet 12 may be electrode sheets having different polarities of an electrode assembly of a secondary battery or may be electrode sheets having the same polarity. In an embodiment, the first electrode sheet 11 and the second electrode sheet 12 may be formed to have a same shape.

The first transporting conveyor 110 may transport the first electrode sheet 11 in the first direction.

The first transporting conveyor 110 according to an embodiment may be a belt conveyor type in which a belt moves in a caterpillar manner by the rotation of a drive pulley. In an embodiment, a belt of the first transporting conveyor 110 may be made of a material having a lower reflectivity than the first electrode sheet 11. However, the first transporting conveyor 110 is not limited thereto and may be varied to any type of transporting unit capable of transporting the first electrode sheet 11 in the first direction, such as a roller conveyor and a chain conveyor.

A longitudinal direction of the first transporting conveyor 110 may be disposed in the first direction. A plurality of first electrode sheets 11 may be arranged on the first transporting conveyor 110 at intervals (e.g., set intervals) in the first direction. In an embodiment, the first transporting conveyor 110 may continuously transport the plurality of first electrode sheets 11 in the first direction by the movement of the belt.

The first transporting conveyor 110 may include a first supply area 111 that receives the first electrode sheet 11 from the supply member 200.

The first supply area 111 according to an embodiment may be an area of an end portion of the first transporting conveyor 110 at which the transport of the first electrode sheet 11 starts among an entire area of the first transporting conveyor 110. The first electrode sheet 11 supplied from the supply member 200 may be seated on the first supply area 111. The electrode sheet 10 seated on the first supply area 111 may be transported in the first direction by the operation of the first transporting conveyor 110.

The second transporting conveyor 120 may transport the second electrode sheet 12 in the direction opposite to the first direction.

The second transporting conveyor 120 according to an embodiment may be a belt conveyor type in which a belt moves in a caterpillar manner by the rotation of a drive pulley. In an embodiment, a belt of the second transporting conveyor 120 may be made of a material having a lower reflectivity than the second electrode sheet 12. However, the second transporting conveyor 120 is not limited thereto and may be varied to any type of transporting unit capable of transporting the second electrode sheet 12 in the direction opposite to the first direction, such as a roller conveyor and a chain conveyor.

A longitudinal direction of the second transporting conveyor 120 may be disposed in the first direction. A plurality of second electrode sheets 12 may be arranged on the second transporting conveyor 120 at intervals (e.g., set intervals) in the direction opposite to the first direction. In an embodiment, the second transporting conveyor 120 may continuously transport the plurality of second electrode sheets 12 in the direction opposite to the first direction by the movement of the belt.

The second transporting conveyor 120 may be disposed to face the first transporting conveyor 110 in the second direction. For example, the second transporting conveyor 120 may be disposed at a position spaced by a distance (e.g., a predetermined distance) from the first transporting conveyor 110 in the direction opposite to the second direction.

The second transporting conveyor 120 may include a second supply area 121 that receives the second electrode sheet 12 from the supply member 200.

The second supply area 121 according to an embodiment may be an area of an end portion of the second transporting conveyor 120 at which the transport of the second electrode sheet 12 starts among an entire area of the second transporting conveyor 120. The second electrode sheet 12 supplied from the supply member 200 may be seated on the second supply area 121. The electrode sheet 10 seated on the second supply area 121 may be transported in the first direction by the operation of the second transporting conveyor 120.

The first supply area 111 and the second supply area 121 may be arranged in the second direction. For example, the second supply area 121 may be disposed at a position spaced by a distance (e.g., a predetermined distance) from the first supply area 111 in the direction opposite to the second direction.

The supply member 200 may supply the first electrode sheet 11 to the first supply area 111 of the first transporting conveyor 110 and supply the second electrode sheet 12 to the second supply area 121 of the second transporting conveyor 120.

The supply member 200 according to an embodiment may include a supply conveyor 210 and a conveying unit 220.

The supply conveyor 210 may transport the first electrode sheet 11 and the second electrode sheet 12 in the second direction.

The supply conveyor 210 according to an embodiment may be a belt conveyor type in which a belt moves in a caterpillar manner by the rotation of a drive pulley.

The supply conveyor 210 may be disposed to intersect the first transporting conveyor 110 and the second transporting conveyor 120. A longitudinal direction of the supply conveyor 210 may be disposed in the second direction. In an embodiment, a plurality of first electrode sheets 11 and a plurality of second electrode sheets 12 may be arranged alternately on the supply conveyor 210 in the second direction. In an embodiment, the supply conveyor 210 may continuously transport the plurality of first electrode sheets 11 and the plurality of second electrode sheets 12 in the second direction by the movement of the belt.

An end portion of the supply conveyor 210 may be disposed to face the second supply area 121 of the second transporting conveyor 120 in the second direction. Therefore, the end portion of the supply conveyor 210, the second supply area 121, and the first supply area 111 may be sequentially arranged in the second direction.

The conveying unit 220 may convey the first electrode sheet 11 and the second electrode sheet 12 transported by the supply conveyor 210 to the first supply area 111 and the second supply area 121, respectively.

The conveying unit 220 according to an embodiment may reciprocate between the supply conveyor 210 and the first transporting conveyor 110. For example, the conveying unit 220 may repeatedly perform an operation of moving from the supply conveyor 210 onto the first transporting conveyor 110 and the second transporting conveyor 120 in the second direction and then moving toward the supply conveyor 210 on the first transporting conveyor 110 and the second transporting conveyor 120 in the direction opposite to the second direction.

The conveying unit 220 may move in the third direction and in the direction opposite to the third direction on the supply conveyor 210 and pick up the first electrode sheet 11 and the second electrode sheet 12. In an embodiment, for example, the conveying unit 220 may include an adsorber for adsorbing the electrode sheet 10 by a vacuum pressure or a gripper for gripping the electrode sheet 10 by a gripping operation.

The conveying unit 220 may move in the third direction toward the electrode sheet 10 on the supply conveyor 210 and have both sides each coming into contact with one of the first electrode sheet 11 and the second electrode sheet 12. The first electrode sheet 11 and the second electrode sheet 12 may be fixed to the conveying unit 220 by an adsorbing or gripping method. Then, the conveying unit 220 may move in the direction opposite to the third direction from the supply conveyor 210 and move toward the first transporting conveyor 110 and the second transporting conveyor 120 in the second direction.

The conveying unit 220 may move from the supply conveyor 210 in the second direction and then move in the third direction and in the direction opposite to the third direction on the transporting conveyor 100 to seat the first electrode sheet 11 and the second electrode sheet 12 on the first supply area 111 and the second supply area 121, respectively.

For example, the conveying unit 220 may move in the third direction in a state in which a side that fixes the first electrode sheet 11 is disposed to face the first supply area 111 and another side that fixes the second electrode sheet 12 is disposed to face the second supply area 121. Then, the conveying unit 220 may seat the first electrode sheet 11 and the second electrode sheet 12 on the first supply area 111 and the second supply area 121 by a method of releasing the adsorption of the first electrode sheet 11 and the second electrode sheet 12 by the adsorber or releasing the grip of the first electrode sheet 11 and the second electrode sheet 12 by the gripper. Then, the conveying unit 220 may move in the direction opposite to the third direction and move in the direction opposite to the second direction toward the supply conveyor 210.

The lighting member 300 may radiate light to the first supply area 111 and the second supply area 121.

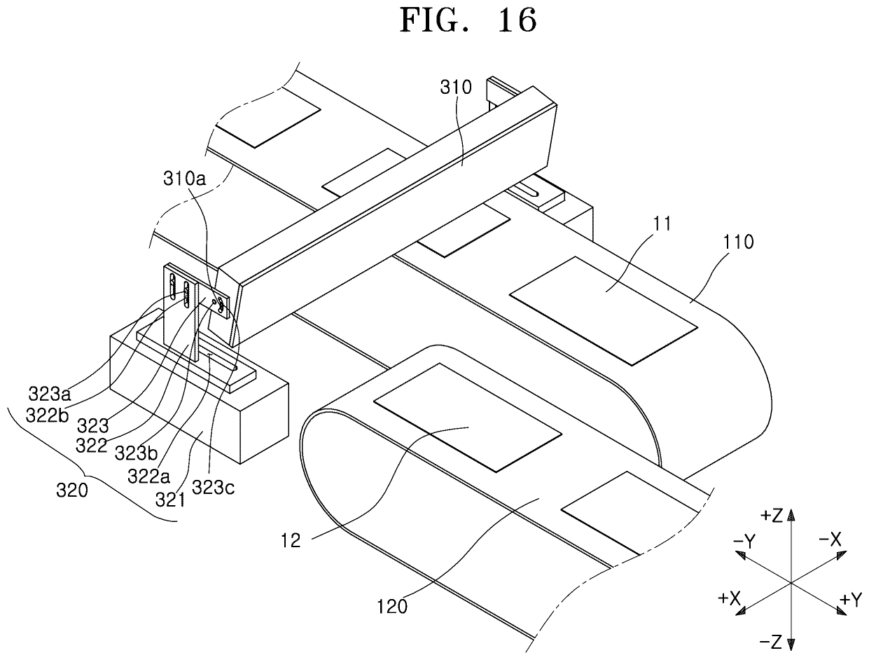

FIG. 16 is a schematic perspective view showing a configuration of a lighting member according to an embodiment of the present disclosure.

Referring to FIGS. 14 to 16, the lighting member 300 according to an embodiment may include the light source 310 and the lighting bracket 320.

The light source 310 may be spaced apart from the transporting conveyor 100 and may radiate light toward the first supply area 111 and the second supply area 121.

The light source 310 according to an embodiment may be disposed above the first transporting conveyor 110. The light source 310 may be disposed at a position spaced by a distance (e.g., a predetermined distance) from the first supply area 111 and the second supply area 121 in the first direction.

In an embodiment, the light source 310 may include a case having a generally rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the first supply area 111 and the second supply area 121 through a surface of the light source 310 disposed to face the first supply area 111 and the second supply area 121.

In an embodiment, a width of the light source 310 in the second direction may be greater than the sum of the width of the first transporting conveyor 110 in the second direction and the width of the first transporting conveyor 110 in the second direction. Therefore, the light source 310 may radiate light over the overall width of the first supply area 111 and the second supply area 121.

The lighting bracket 320 may support the light source 310.

The lighting bracket 320 according to an embodiment may include the first lighting bracket 321, the second lighting bracket 322, and the third lighting bracket 323.

The first lighting bracket 321 may form an exterior of a side of the lighting bracket 320 and support the second lighting bracket 322.

In an embodiment, a pair of first lighting brackets 321 may be provided. The pair of first lighting brackets 321 may be disposed to face each other in the second direction. In an embodiment, a space between the pair of first lighting brackets 321 may be greater than the width of the light source 310 in the second direction. The first lighting bracket 321 may be fixed to frames of the first transporting conveyor 110 and the second transporting conveyor 120 or may be fixed on the ground, for example.

The second lighting bracket 322 and the third lighting bracket 323 may be formed in a same manner as the second lighting bracket 322 and the third lighting bracket 323 described with reference to FIGS. 1 to 13.

The sensing member 400 may be disposed to face the lighting member 300. The sensing member 400 may detect the presence or absence of the first electrode sheet 11 and the second electrode sheet 12 on the first supply area 111 and the second supply area 121 based on light radiated from the lighting member 300. The sensing member 400 may detect the light reflected from the first electrode sheet 11 positioned on the first supply area 111 and the second electrode sheet 12 positioned on the second supply area 121.

The sensing member 400 according to an embodiment may include the camera 410 and the camera bracket 420.

The camera 410 may acquire optical images of the first supply area 111 and the second supply area 121.

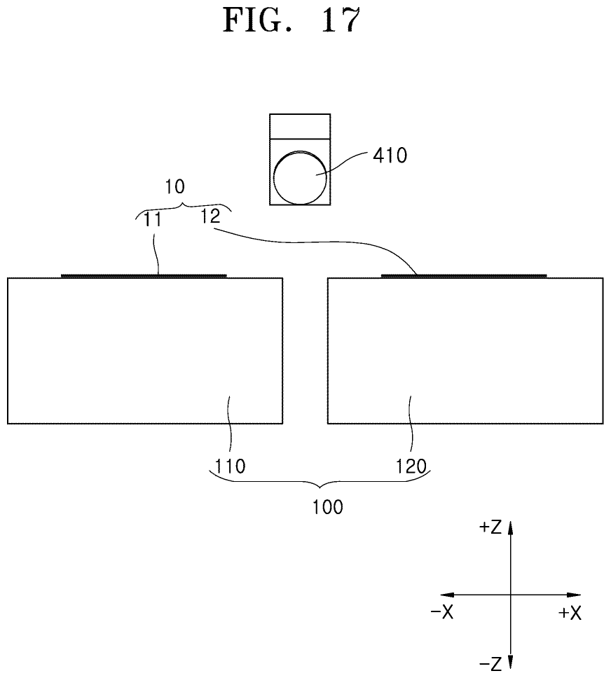

FIG. 17 is a schematic view showing a configuration of a camera according to an embodiment of the present disclosure.

Referring to FIGS. 14 to 17, the camera 410 according to an embodiment may be any type of optical device capable of detecting the light reflected from the first electrode sheet 11 positioned on the first supply area 111 and the second electrode sheet 12 positioned on the second supply area 121, such as a mono camera, a color camera, or a vision sensor.

In an embodiment, the camera 410 may be disposed between the first transporting conveyor 110 and the second transporting conveyor 120. Therefore, the camera may uniformly or substantially uniformly detect the light reflected from the first electrode sheet 11 and the second electrode sheet 12 positioned on the second supply area 121.

The camera 410 may be disposed to face the lighting member 300, and, in an embodiment, the light source 310 in the first direction. The camera 410 may be disposed to face the light source 310 in the first direction with the first supply area 111 and the second supply area 121 interposed therebetween. The camera 410 may be disposed at a position spaced by a distance (e.g., a predetermined distance) from the lighting member 300 in the direction opposite to the first direction.

The camera bracket 420 may support the camera 410.

The camera bracket 420 according to an embodiment may be formed in a same manner as the camera bracket 420 described with reference to FIGS. 1 to 13.

The control member 500 may control an overall operation of the first transporting conveyor 110, the second transporting conveyor 120, the supply member 200, the lighting member 300, and the sensing member 400.

The control member 500 may control the supply operation of the supply member 200 based on information detected from the sensing member 400. In an embodiment, the control member 500 may determine the presence or absence of the first electrode sheet 11 on the first supply area 111 and the presence or absence of the second electrode sheet 12 on the second supply area 121 based on information detected from the sensing member 400. When the control member 500 determines that the first electrode sheet 11 and the second electrode sheet 12 are not present on both the first supply area 111 and the second supply area 121, the control member 500 may operate the supply member 200. When the control member 500 determines that the first electrode sheet 11 and the second electrode sheet 12 are present on at least one of the first supply area 111 and the second supply area 121, the control member 500 may stop the operation of the supply member 200. Therefore, the control member 500 can prevent or substantially prevent two or more electrode sheets 10 from overlapping at a same position on the first transporting conveyor 110 and the second transporting conveyor 120.

In an embodiment, the control member 500 may control operation of a drive pulley of the first transporting conveyor 110 to adjust a transporting speed of the first electrode sheet 11, a transporting direction of the first electrode sheet 11, whether the first electrode sheet 11 is transported, and the like.

In an embodiment, the control member 500 may control operation of a drive pulley of the second transporting conveyor 120 to adjust a transporting speed of the second electrode sheet 12, a transporting direction of the second electrode sheet 12, whether the second electrode sheet 12 is transported, and the like.

In an embodiment, the control member 500 may control operations of actuators of the lighting member 300 and the sensing member 400 to adjust the positions, angles, and the like of the light source 310 and the camera 410.

Herein, operation of the electrode sheet transporting apparatus according to the present embodiment of the present disclosure will be described.

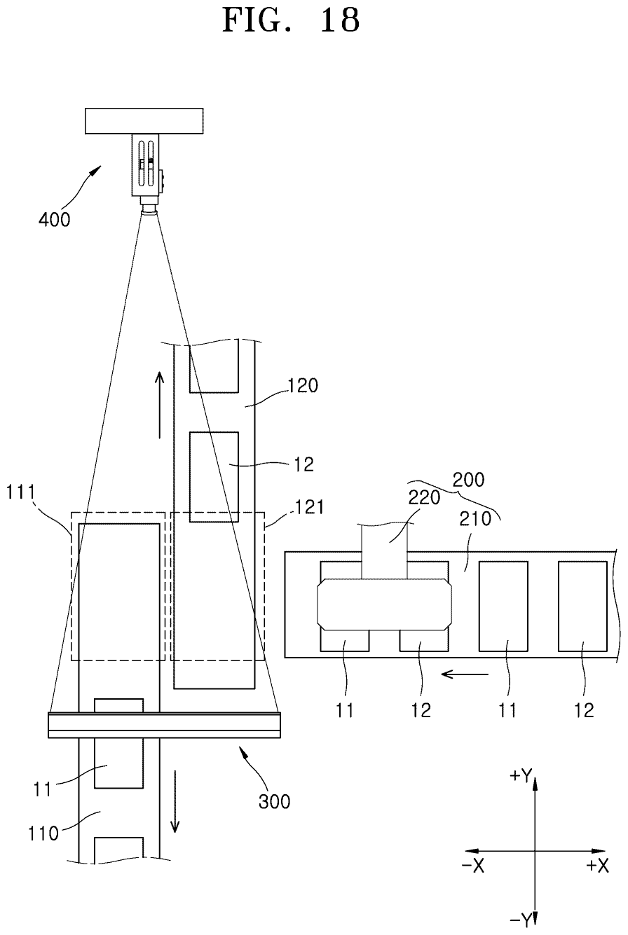

FIGS. 18 to 21 are schematic views showing an operation process of the electrode sheet transporting apparatus according to an embodiment of the present disclosure.

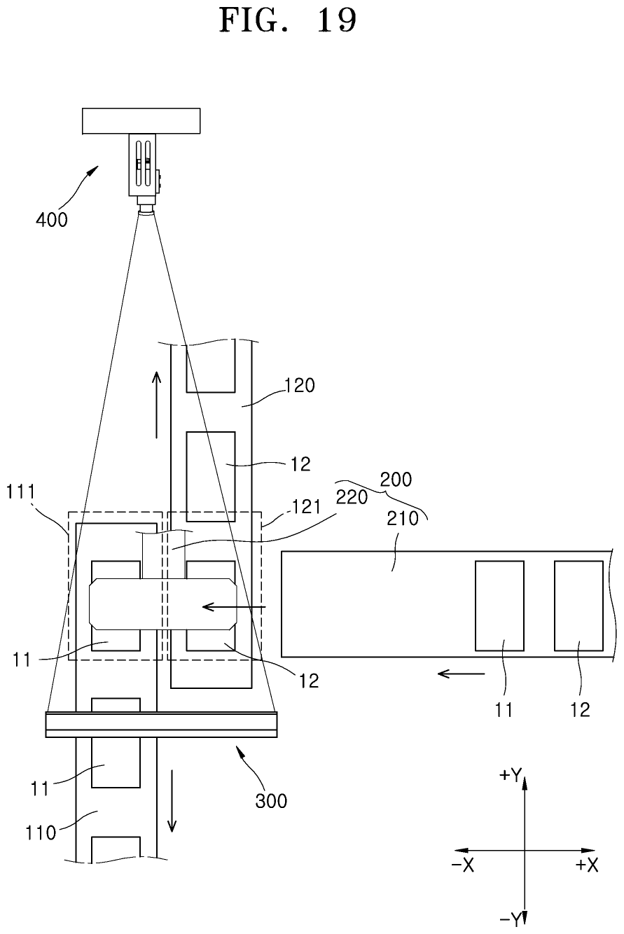

Referring to FIGS. 18 and 19, when the first transporting conveyor 110 operates, the first electrode sheet 11 positioned on the first supply area 111 moves from the first supply area 111 in the first direction, and the first electrode sheet 11 is not present on the first supply area 111.

When the second transporting conveyor 120 operates, the second electrode sheet 12 positioned on the second supply area 121 moves from the second supply area 121 in the direction opposite to the first direction, and the second electrode sheet 12 is not present on the second supply area 121.

If both the first electrode sheet 11 and the second electrode sheet 12 are not present on the first supply area 111 and the second supply area 121, the light radiated from the light source 310 to the first supply area 111 and the second supply area 121 is not reflected from the first supply area 111 and the second supply area 121 or is reflected with a same reflectivity over an entire area of the first supply area 111 and the second supply area 121.

Therefore, light is not incident on the camera 410, or light with a same brightness is incident on the entire area of the first supply area 111 and the second supply area 121, and the control member 500 determines that the electrode sheet 10 is not present on the first supply area 111 and the second supply area 121.

Then, the control member 500 operates the supply member 200 such that the first electrode sheet 11 and the second electrode sheet 12 are supplied to the first supply area 111 and the second supply area 121.

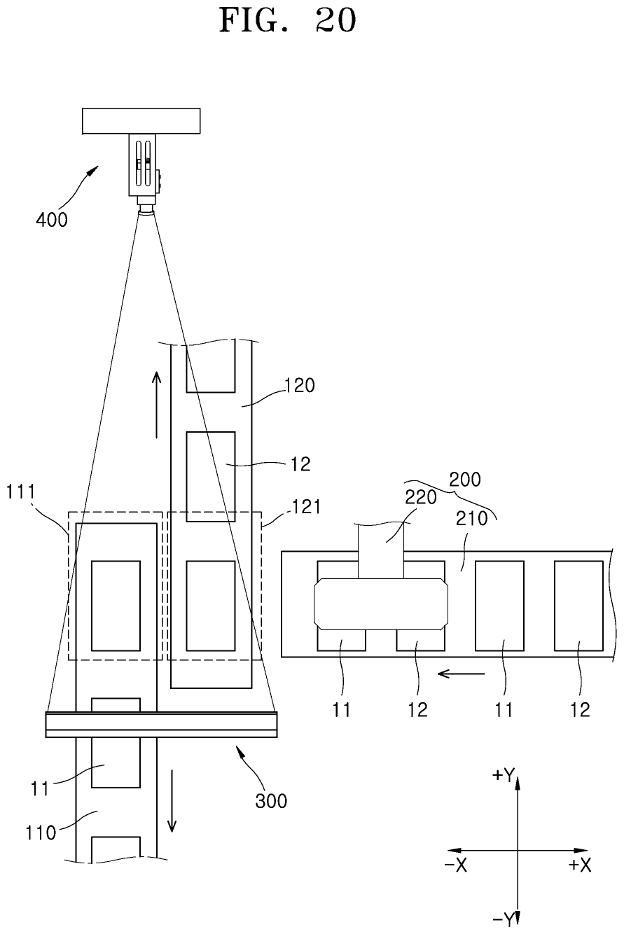

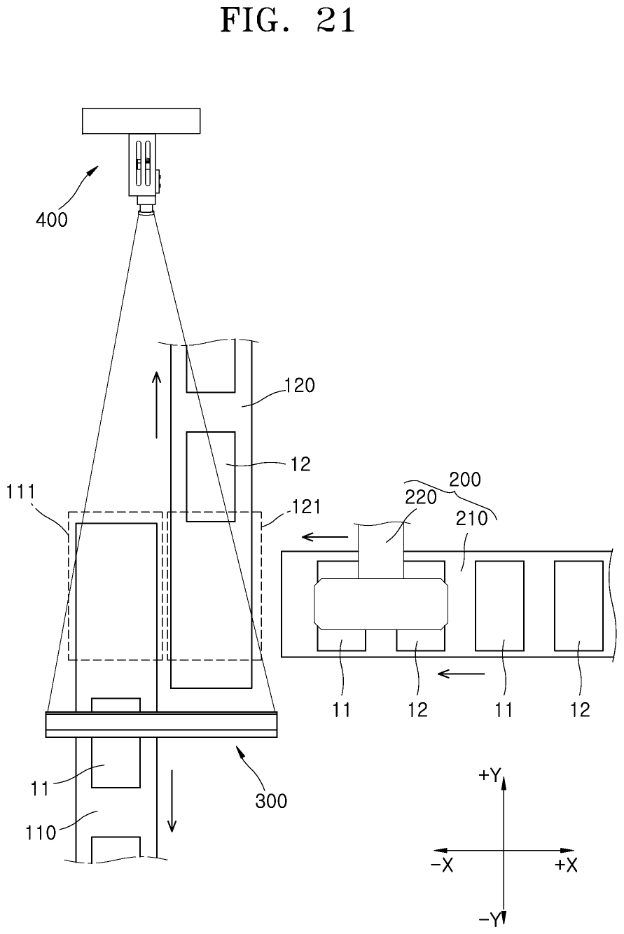

Referring to FIGS. 20 and 21, if an operation error occurs in the first transporting conveyor 110, the first electrode sheet 11 positioned on the first supply area 111 moves in the first direction, and the first electrode sheet 11 is present on the first supply area 111.

In an embodiment, the first electrode sheet 11 is made of a material having a higher reflectivity than the belt of the first transporting conveyor 110, and light of different brightness is incident on the camera 410 in the area in which the first electrode sheet 11 is positioned and in the area in which the first electrode sheet 11 is not positioned of the first supply area 111, and the control member 500 may determine that the first electrode sheet 11 is present on the first supply area 111.

If an operation error occurs in the second transporting conveyor 120, the second electrode sheet 12 positioned on the second supply area 121 does not move in the direction opposite to the first direction, and the second electrode sheet 12 is present on the second supply area 121.

In an embodiment, the second electrode sheet 12 is made of a material having a higher reflectivity than the belt of the second transporting conveyor 120, and light of different brightness is incident on the camera 410 in the area in which the second electrode sheet 12 is positioned and in the area in which the second electrode sheet 12 is not positioned of the second supply area 121, and the control member 500 may determine that the second electrode sheet 12 is present on the second supply area 121.

If the control member 500 determines that the first electrode sheet 11 and the second electrode sheet 12 are present on at least one of the first supply area 111 and the second supply area 121, the control member 500 stops the operation of the supply member 200 such that the first electrode sheet 11 and the second electrode sheet 12 are not supplied to the first supply area 111 and the second supply area 121.

Herein, an operation of an electrode sheet transporting apparatus according to another embodiment of the present disclosure will be described.

The electrode sheet transporting apparatus according to the present embodiment may be formed to differ only in the configuration of the lighting member 300 from the electrode sheet transporting apparatus of FIG. 14.

Therefore, in describing the electrode sheet transporting apparatus according to the present embodiment, only the configuration of the lighting member 300 that differs from the electrode sheet transporting apparatus of FIG. 14 will be described.

The description of the electrode sheet transporting apparatus of FIG. 14 may be applied to the remaining configuration of the electrode sheet transporting apparatus according to the present embodiment.

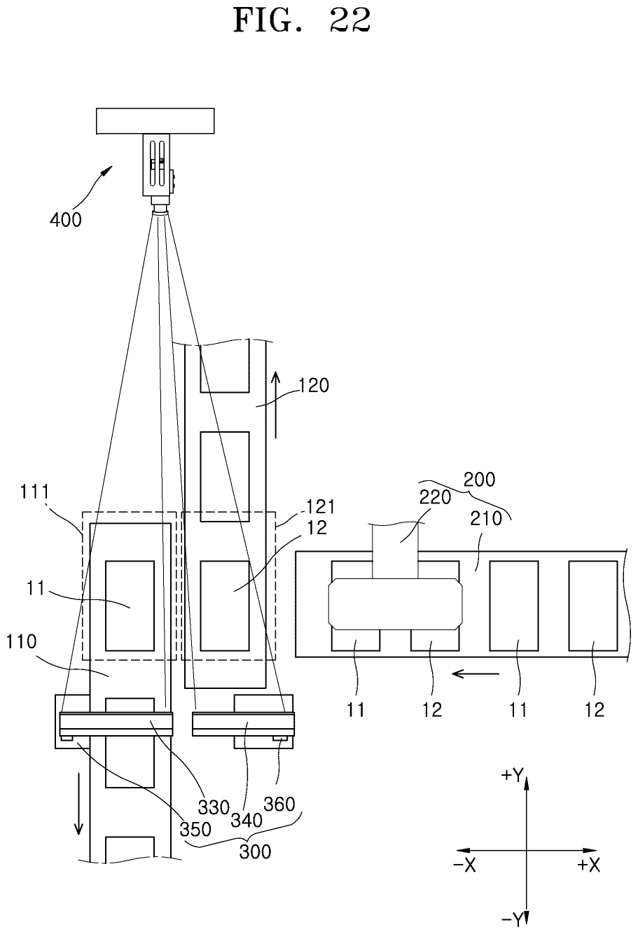

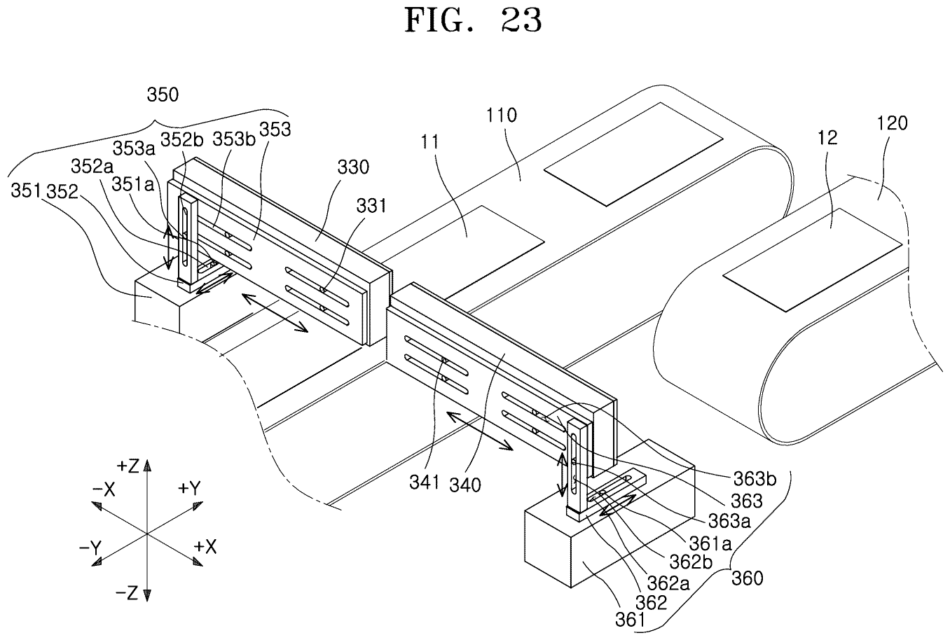

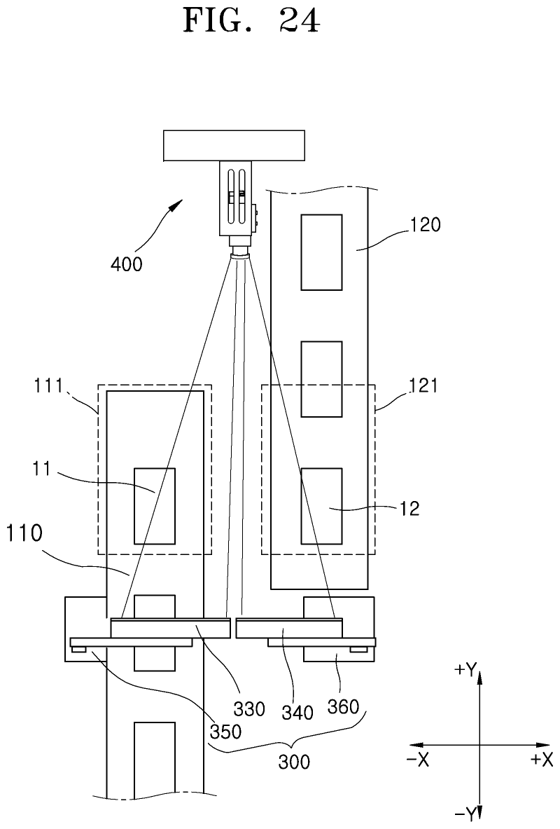

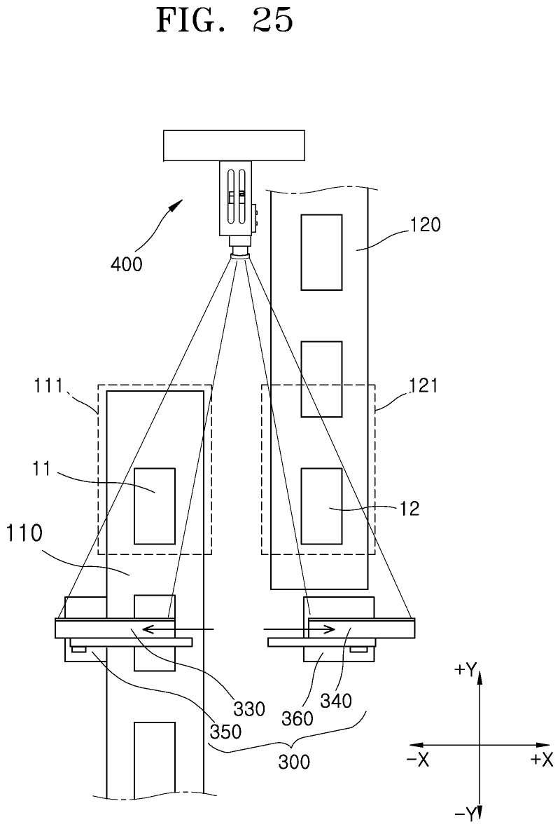

FIG. 22 is a schematic view showing a configuration of an electrode sheet transporting apparatus according to an embodiment of the present disclosure; FIG. 23 is a schematic perspective view showing a configuration of a lighting member according to an embodiment of the present disclosure; and FIGS. 24 and 25 are schematic views showing an operation process of the lighting member of FIG. 23.

Referring to FIGS. 21 to 24, the lighting member 300 according to the present embodiment may include a first light source 330, a second light source 340, a first support bracket 350, and a second support bracket 360. Therefore, the lighting member 300 according to the present embodiment may independently adjust a brightness, position, and the like of light radiated to the first supply area 111 and the second supply area 121.

The first light source 330 may radiate light to the first supply area 111.

The first light source 330 according to an embodiment may be disposed above the first transporting conveyor 110. The first light source 330 may be disposed to face the first transporting conveyor 110 in the third direction and may not be disposed to face the first transporting conveyor 110 in the third direction. The first light source 330 may be disposed at a position spaced by a distance (e.g., a predetermined distance) from the first supply area 111 in the first direction.

In an embodiment, the first light source 330 may include a case having a generally rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the first supply area 111 through a surface of the first light source 330 disposed to face the first supply area 111.

In an embodiment, a width of the first light source 330 in the second direction may be greater than a width of the first transporting conveyor 110 in the second direction. Therefore, the first light source 330 may radiate light over an overall width of the first supply area 111.

The second light source 340 may radiate light to the second supply area 121.

The second light source 340 according to an embodiment may be disposed above the second transporting conveyor 120. The second light source 340 may not be disposed to face the second transporting conveyor 120 in the third direction and may be disposed to face the second transporting conveyor 120 in the third direction. The second light source 340 may be disposed at a position spaced by a distance (e.g., a predetermined distance) from the second supply area 121 in the first direction.

In an embodiment, the second light source 340 may include a case having a generally rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the second supply area 121 through a surface of the second light source 340 disposed to face the second supply area 121.

In an embodiment, a width of the second light source 340 in the second direction may be greater than a width of the second transporting conveyor 120 in the second direction. Therefore, the second light source 340 may radiate light over the overall width of the second supply area 121.

The first light source 330 and the second light source 340 may be disposed to face each other in the second direction. The second light source 340 may be disposed at a position spaced by a distance (e.g., a predetermined distance) from the first light source 330 in the direction opposite to the second direction.

The first support bracket 350 may support the first light source 330.

The first support bracket 350 according to an embodiment may include a first bracket body 351, a first connection bracket 352, and a first extension bracket 353.

The first bracket body 351 may form an exterior of a side of the first support bracket 350 and support the first connection bracket 352.

The first bracket body 351 according to an embodiment may be disposed to face the first transporting conveyor 110 in the second direction. The first bracket body 351 may be disposed at a position spaced by a distance (e.g., a predetermined distance) from the first transporting conveyor 110 in the second direction. The first bracket body 351 may be fixed to a frame of the first transporting conveyor 110 or may be fixed on the ground, for example. However, a shape of the first bracket body 351 is not limited to the shapes shown in FIGS. 22 and 23 and may be varied within the technical spirit of the shape capable of supporting the first connection bracket 352.

The first connection bracket 352 may be connected to the first bracket body 351 to support the first extension bracket 353.

The first connection bracket 352 according to an embodiment may have a shape in which a lower side is seated on the first bracket body 351 and an upper side extends upward from the first bracket body 351, that is, in the direction opposite to the third direction. In an embodiment, a height of an upper end portion of the first connection bracket 352 may be greater than a height of the first electrode sheet 11 seated on the first transporting conveyor 110. Therefore, the first connection bracket 352 can prevent or substantially prevent interference between the first light source 330 and the first electrode sheet 11.

The first connection bracket 352 may be connected to the first bracket body 351 to be movable in the first direction and in the direction opposite to the first direction. Therefore, the first connection bracket 352 may adjust a space between the first light source 330 and the sensing member 400.

In an embodiment, for example, the lighting member 300 may further include a first horizontal rail 352a passing through the first connection bracket 352. The first horizontal rail 352a according to an embodiment may pass through a lower portion of the first connection bracket 352 seated on the first bracket body 351 in the third direction. A longitudinal direction of the first horizontal rail 352a may extend in the first direction.

The lighting member 300 may further include a first vertical pin 351a protruding from the first bracket body 351 and inserted into the first horizontal rail 352a. The first vertical pin 351a according to an embodiment may have a rod shape that extends from an upper surface of the first bracket body 351 on which the first connection bracket 352 is seated in the direction opposite to the third direction.

The first connection bracket 352 may slide in the first direction or in the direction opposite to the first direction by an external force applied from the outside in a state in which the first vertical pin 351a is inserted into the first horizontal rail 352a.

However, a connection relationship between the first bracket body 351 and the first connection bracket 352 is not limited to the above-described shape and may be varied within the range of a structure in which the first connection bracket 352 may move relatively with respect to the first bracket body 351 in the first direction.

The first extension bracket 353 may extend from the first connection bracket 352 to support the first light source 330.

The first extension bracket 353 according to an embodiment may have a plate shape that extends from the upper end portion of the first connection bracket 352 in the direction opposite to the second direction. A rear surface of the first extension bracket 353 may be disposed to face the upper end portion of the first connection bracket 352 in the first direction. A front surface of the first extension bracket 353 may be disposed to face a rear surface of the first light source 330 in the first direction.

The first extension bracket 353 may be connected to the first connection bracket 352 to be movable in the third direction or in the direction opposite to the third direction. Therefore, the first extension bracket 353 may adjust a height of the first light source 330 in response to a difference in height between the conveying unit 220 and the first supply area 111 when the first electrode sheet 11 is supplied.

In an embodiment, for example, the lighting member 300 may further include a first vertical rail 352b passing through the first connection bracket 352. The first vertical rail 352b according to an embodiment may pass through the upper end portion of the first connection bracket 352 facing the rear surface of the first extension bracket 353 in the first direction. A longitudinal direction of the first vertical rail 352b may extend in the third direction.

The lighting member 300 may further include a first horizontal pin 353a protruding from the first extension bracket 353 and inserted into the first vertical rail 352b. The first horizontal pin 353a according to an embodiment may have a rod shape that extends from an end portion of the first extension bracket 353 facing the first connection bracket 352 in the direction parallel to the first direction.

The first extension bracket 353 may slide in the third direction or in the direction opposite to the third direction by an external force applied from the outside in a state in which the first horizontal pin 353a is inserted into the first vertical rail 352b.

The first light source 330 may be connected to the first extension bracket 353 to be movable in the second direction or in the direction opposite to the second direction. Therefore, the lighting member 300 according to an embodiment may adjust an incident angle of light incident on the camera 410 according to the size of the first electrode sheet 11 seated on the first supply area 111 or the like.

For example, the lighting member 300 may further include a first guide rail 353b passing through the first extension bracket 353. The first guide rail 353b according to an embodiment may pass through the front and rear surfaces of the first extension bracket 353 in the first direction. A longitudinal direction of the first guide rail 353b may extend in the second direction.

The lighting member 300 may further include a first guide pin 331 protruding from the first light source 330 and inserted into the first guide rail 353b. The first guide pin 331 according to an embodiment may have a rod shape that extends from the rear surface of the first light source 330 facing the first extension bracket 353 in the first direction.

The first light source 330 may slide in the second direction or in the direction opposite to the second direction by an external force applied from the outside in a state in which the first guide pin 331 is inserted into the first guide rail 353b.

The second support bracket 360 may support the second light source 340.

The second support bracket 360 according to an embodiment may include a second bracket body 361, a second connection bracket 362, and a second extension bracket 363.

The second bracket body 361 may form an exterior of a side of the second support bracket 360 and support the second connection bracket 362.

The second bracket body 361 according to an embodiment may be disposed to face the first bracket body 351 in the second direction. The second bracket body 361 may be disposed at a position spaced by a distance (e.g., a predetermined distance) from the first bracket body 351 in the direction opposite to the second direction. In an embodiment, a space between the first bracket body 351 and the second bracket body 361 may be greater than a space between the outer surfaces of the first transporting conveyor 110 and the second transporting conveyor 120. The second bracket body 361 may be fixed to the frame of the first transporting conveyor 110 or the second transporting conveyor 120 or may be fixed on the ground, for example. However, a shape of the second bracket body 361 is not limited to the shapes shown in FIGS. 22 and 23 and may be varied within the technical spirit of the shape capable of supporting the second connection bracket 362.

The second connection bracket 362 may be connected to the second bracket body 361 to support the second extension bracket 363.

The second connection bracket 362 according to an embodiment may have a shape in which a lower side is seated on the second bracket body 361 and an upper side extends upward from the second bracket body 361, that is, in the direction opposite to the third direction. In an embodiment, a height of an upper end portion of the second connection bracket 362 may be greater than a height of the second electrode sheet 12 seated on the second transporting conveyor 120. Therefore, the second connection bracket 362 can prevent or substantially prevent interference between the second light source 340 and the second electrode sheet 12.

The second connection bracket 362 may be connected to the second bracket body 361 to be movable in the first direction and in the direction opposite to the first direction. Therefore, the second connection bracket 362 may adjust a space between the second light source 340 and the sensing member 400.

For example, the lighting member 300 may further include a second horizontal rail 362a passing through the second connection bracket 362. The second horizontal rail 362a according to an embodiment may pass through a lower portion of the second connection bracket 362 seated on the second bracket body 361 in the third direction. A longitudinal direction of the second horizontal rail 362a may extend in the first direction.

The lighting member 300 may further include a second vertical pin 361a protruding from the second bracket body 361 and inserted into the second horizontal rail 362a. The second vertical pin 361a according to an embodiment may have a rod shape that extends from an upper surface of the second bracket body 361 on which the second connection bracket 362 is seated in the direction opposite to the third direction.

The second connection bracket 362 may slide in the first direction or in the direction opposite to the first direction by an external force applied from the outside in a state in which the second vertical pin 361a is inserted into the second horizontal rail 362a.

However, a connection relationship between the second bracket body 361 and the second connection bracket 362 is not limited to the above-described shape and may be varied within the range of a structure in which the second connection bracket 362 may move relatively with respect to the second bracket body 361 in the first direction.

The second extension bracket 363 may extend from the second connection bracket 362 to support the second light source 340.

The second extension bracket 363 according to an embodiment may have a plate shape that extends from the upper end portion of the second connection bracket 362 in the second direction. A rear surface of the second extension bracket 363 may be disposed to face the upper end portion of the second connection bracket 362 in the first direction. A front surface of the second extension bracket 363 may be disposed to face a rear surface of the second light source 340 in the first direction.

The second extension bracket 363 may be connected to the second connection bracket 362 to be movable in the third direction or in the direction opposite to the third direction. Therefore, the second extension bracket 363 may adjust a height of the second light source 340 in response to a difference in height between the conveying unit 220 and the second supply area 121 when the second electrode sheet 12 is supplied.

In an embodiment, for example, the lighting member 300 may further include a second vertical rail 362b passing through the second connection bracket 362. The second vertical rail 362b according to an embodiment may pass through the upper end portion of the second connection bracket 362 facing the rear surface of the second extension bracket 363 in the first direction. A longitudinal direction of the second vertical rail 362b may extend in the third direction.

The lighting member 300 may further include a second horizontal pin 363a protruding from the second extension bracket 363 and inserted into the second vertical rail 362b. The second horizontal pin 363a according to an embodiment may have a rod shape that extends from an end portion of the second extension bracket 363 facing the second connection bracket 362 in the direction parallel to the first direction.

The second extension bracket 363 may slide in the third direction or in the direction opposite to the third direction by an external force applied from the outside in a state in which the second horizontal pin 363a is inserted into the second vertical rail 362b.

The second light source 340 may be connected to the second extension bracket 363 to be movable in the second direction or in the direction opposite to the second direction. Therefore, the lighting member 300 according to an embodiment may adjust an incident angle of light incident on the camera 410 according to the size of the second electrode sheet 12 seated on the second supply area 121 or the like.

In an embodiment, for example, the lighting member 300 may further include a second guide rail 363b passing through the second extension bracket 363. The second guide rail 363b according to an embodiment may pass through front and rear surfaces of the second extension bracket 363 in the first direction. A longitudinal direction of the second guide rail 363b may extend in the second direction.

The lighting member 300 may further include a first guide pin 341 protruding from the second light source 340 and inserted into the second guide rail 363b. The first guide pin 341 according to an embodiment may have a rod shape that extends from the rear surface of the second light source 340 facing the second extension bracket 363 in the first direction.

The second light source 340 may slide in the second direction or in the direction opposite to the second direction by an external force applied from the outside in a state in which the first guide pin 341 is inserted into the second guide rail 363b.

The lighting member 300 according to an embodiment may further include an actuator, such as a motor, and a power transmission unit, such as a reducer, to move or rotate the first light source 330, the second light source 340, the first support bracket 350, and the second support bracket 360 by their own driving force.

Herein, an electrode sheet transporting apparatus according to another embodiment of the present disclosure will be described.

The electrode sheet transporting apparatus according to the present embodiment may be formed to differ only in a configuration of the lighting member 300 from the electrode sheet transporting apparatus of FIG. 22.

Therefore, in describing the electrode sheet transporting apparatus according to the present embodiment, only the configuration of the lighting member 300 that differs from the electrode sheet transporting apparatus of FIG. 22 will be described.

The description of the electrode sheet transporting apparatus according to FIG. 22 may be applied to the remaining configuration of the electrode sheet transporting apparatus according to the present embodiment.

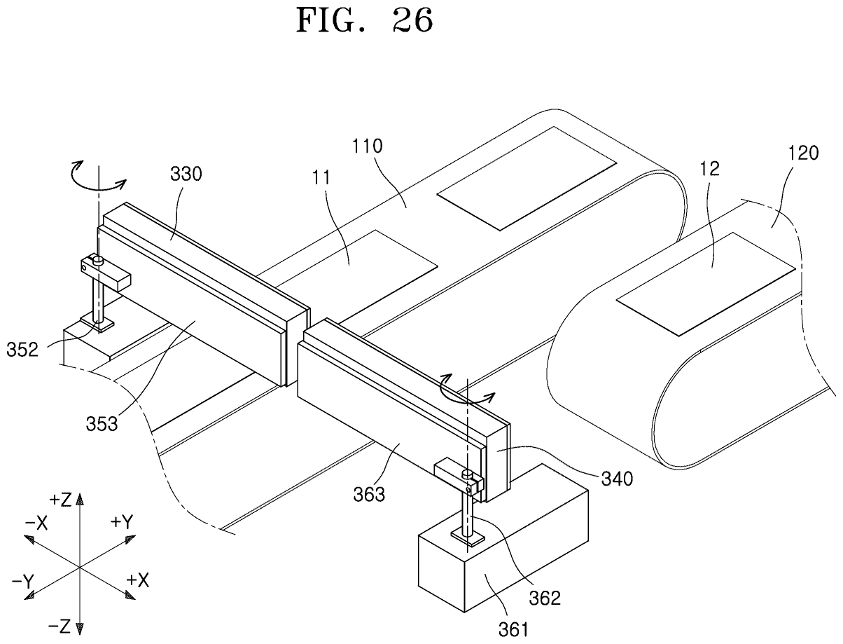

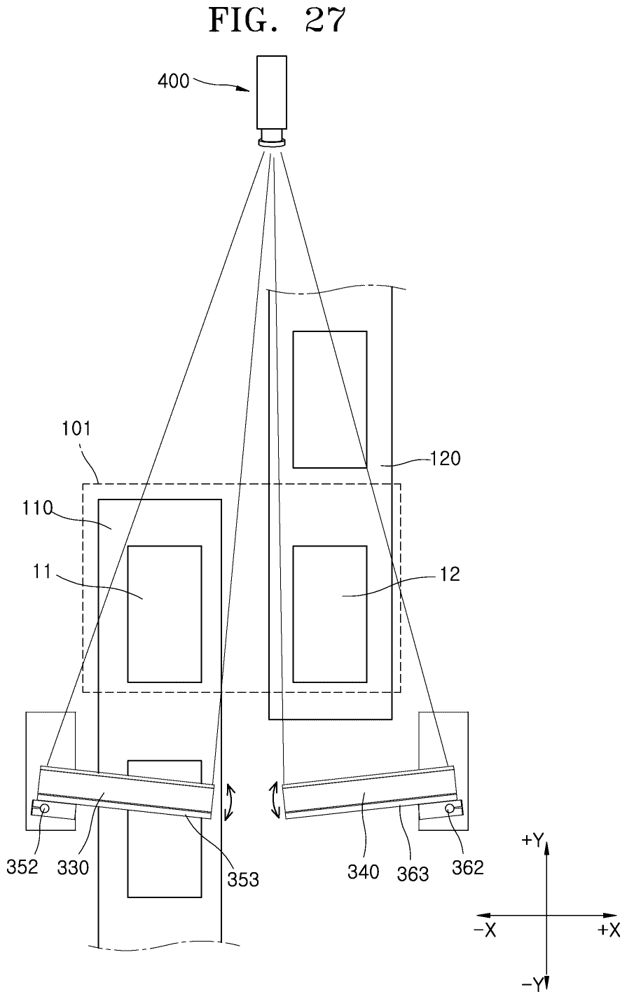

FIG. 26 is a schematic view showing a configuration of a lighting member according to an embodiment of the present disclosure; and FIG. 27 is a schematic view showing an operation of the lighting member of FIG. 26.

Referring to FIGS. 26 and 27, the first extension bracket 353 according to the present embodiment may be rotatably connected to the first connection bracket 352 clockwise or counterclockwise with respect to the third direction.

In an embodiment, for example, the first connection bracket 352 may have a cylindrical shape that extends from the first bracket body 351 in the direction opposite to the third direction. The upper end portion of the first connection bracket 352 may be inserted into the first extension bracket 353 to rotatably support the first extension bracket 353. The first extension bracket 353 may be rotated about a central axis of the first connection bracket 352 clockwise or counterclockwise by an external force applied from the outside.

The second extension bracket 363 according to an embodiment may be rotatably connected to the second connection bracket 362 clockwise or counterclockwise with respect to the third direction.

In an embodiment, for example, the second connection bracket 362 may have a cylindrical shape that extends from the second bracket body 361 in the direction opposite to the third direction. The upper end portion of the second connection bracket 362 may be inserted into the second extension bracket 363 to rotatably support the second extension bracket 363. The second extension bracket 363 may be rotated about a central axis of the second connection bracket 362 clockwise or counterclockwise by an external force applied from the outside.

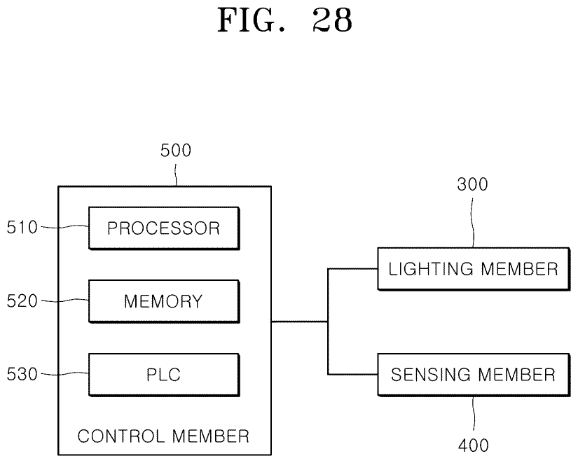

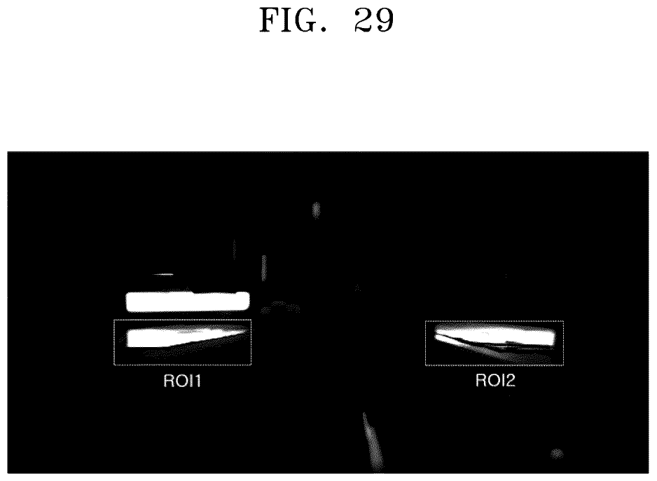

FIG. 28 is a block diagram illustrating an apparatus for detecting an electrode sheet according to an embodiment of the present invention; and FIGS. 29 to 42 are diagrams for describing a process for determining whether an electrode sheet is present in a supply region of a transport conveyor by the apparatus for detecting an electrode sheet according to an embodiment of the present invention.

In an embodiment, as described above, the belt of the transport conveyor 100 may be formed of a material with lower light reflectance than the electrode sheet 10, and the electrode sheet 10 is formed of a metal material, and when the lighting member 300 illuminates the supply region 101 of the transport conveyor 100, a quantity of light reflected from the electrode sheet 10 is greater than a quantity of light of light reflected from the belt of the transport conveyor 100. Thus, the control member 500 may determine whether the electrode sheet 10 is present in the supply region 101 through a difference in light reflectance between the electrode sheet 10 and the transport conveyor 100. Herein, a method of determining whether the electrode sheet 10 is present in the supply region 101 of the transport conveyor 100 will be described in further detail.

Referring to FIG. 28, the apparatus for detecting an electrode sheet according to an embodiment may include the lighting member 300, the sensing member 400, and the control member 500. The lighting member 300, the sensing member 400, and the control member 500 correspond to components constituting the above-described apparatus for transporting an electrode sheet, and, therefore, the apparatus for detecting an electrode sheet may correspond to components constituting the apparatus for transporting an electrode sheet. That is, the apparatus for detecting an electrode sheet may constitute the apparatus for transporting an electrode sheet together with the transport conveyor 100 and the supply member 200, which are equipment for transporting and supplying an electrode.

As shown in FIG. 28, in an embodiment, the control member 500 may include a processor 510, a memory 520, and a programmable logic controller (PLC) 530.

The processor 510 is a subject performing an operation of detecting an electrode sheet, which will be described below, and may function as a superordinate controller of the PLC 530 which will be described below. The processor 150 may be implemented as a central processing unit (CPU) or a system on chip (SoC), may run an operating system or an application to control a plurality of hardware or software components, and may process various types of data processing and perform various arithmetic operations. The processor 510 may execute at least one command stored in the memory 520 and store the execution result data in the memory 520.

At least one command executed by the processor 510 may be stored in the memory 520. In addition, in the present embodiment, the memory 520 may store an algorithm (a program or applet) for the operation of detecting an electrode sheet which will be described below. The memory 520 may be implemented as a volatile storage medium and/or a non-volatile storage medium, for example, as a read-only memory (ROM) and/or a random-access memory (RAM).

The PLC 530 may control operations of the above-described transport conveyor 100 and supply member 200 under the control of the processor 510. That is, when the processor 510 controls transport of the electrode sheet 10 through the transport conveyor 100, the processor 510 may transmit a control command including information on a transport speed and transport direction of the electrode sheet 10 and whether the electrode sheet 10 has been transported as well as information on the operation of the supply member 200 to the PLC 530. In response to the control command received from the processor 510, the PLC 530 may control the transport speed and transport direction of the electrode sheet 10 and whether the electrode sheet 10 has been transported, control the transport conveyor 100 and a drive pulley of the supply conveyor 210, and control the operation of the transport unit 220 to control the operation of the supply member 200.

The operation of the processor 510 will be described in further detail. The operation of the processor 510, which will be described below, may be applied to the embodiment of detecting the presence or absence of the electrode sheet 10 in the supply region 101 of the transport conveyor 100 during the process of transporting the electrode sheet 10 through a single transport conveyor 100 as shown in FIG. 1 and may be applied to the embodiments of detecting the presence or absence of the first and second electrode sheets 11 and 12 in the supply regions 111 and 121 of the first and second transport conveyors 110 and 120 during the process of transporting the first and second electrode sheets 11 and 12 through two transport conveyors (i.e., the first and second transport conveyors 110 and 120) as shown in FIGS. 14, 22, and 26. In the case of the embodiments of FIGS. 14, 22, and 26, the operation of detecting an electrode sheet, which will be described below, may be performed independently for each of the transport conveyors 110 and 120.

The processor 510 according to an embodiment may analyze a target image of the supply region 101, which is generated on the basis of a result of the sensing member 400 detecting reflected light formed by light emitted from the lighting member 300 and reflected from the supply region 101, to determine whether the electrode sheet 10 is present in the supply region 101.

In an embodiment, while the light emitted from the lighting member 300 is emitted to the supply region 101 of the transport conveyor 100, the sensing member 400 may detect the reflected light formed by the light emitted from the lighting member 300 and reflected from the supply region 101 under the control of the processor 510 (or the PLC 530) (i.e., capturing an image of the supply region 101) to generate an image of the supply region 101. The image generated by the sensing member 400 may be defined as a raw image, and the raw image may have a grayscale. The sensing member 400 may generate the raw image at a frame rate of, for example, 20 to 50 frames per second (FPS) and transmit the raw image to the processor 510.

The processor 510 may receive the raw image generated by the sensing member 400 through a graphic user interface (GUI), and a reception speed may depend on the frame rate of the sensing member 400 (e.g., 20 to 50 FPS in the above example). Prior to performing the operation of detecting an electrode sheet, the processor 510 may crop a region of a raw image corresponding to a certain, or defined, (e.g., predefined) region of interest (ROI) to generate an image to be analyzed. The image in which the raw image is cropped according to the ROI may be defined as a target image. The supply member 200 of the present embodiment may operate to seat the electrode sheet 10 in a region (e.g., a pre-designed region) within the supply region 101 of the transport conveyor 100, and the above-described ROI may correspond to coordinate information (based on the coordinate system of the image) corresponding to a region where the electrode sheet 10 is seated. The time and arithmetic operation resources required for detecting the electrode sheet 10 in the supply region 101 may be reduced by analyzing the target image in which the region where the electrode sheet 10 is seated is extracted from the raw image rather than analyzing the raw image.

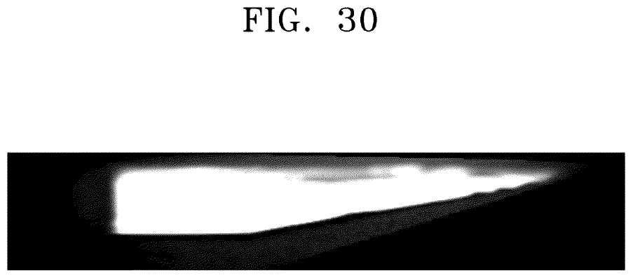

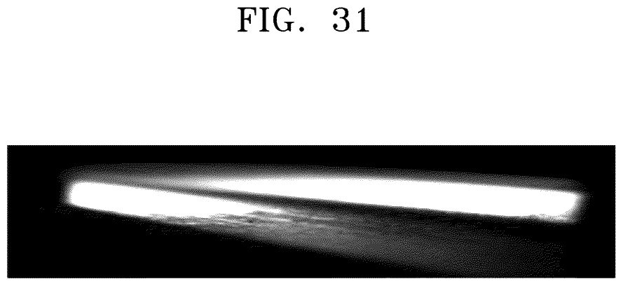

FIG. 29 shows an example of a raw image generated by the sensing member 400 when one sensing member 400 captures images of the first and second supply regions 111 and 121 provided in the first and second transport conveyors (e.g., the first and second transport conveyors 110 and 120 in FIG. 14). In this case, first and second ROIs for detecting the first and second electrode sheets 11 and 12 in the first and second supply regions 111 and 121 may be defined (e.g., predefined) in the processor 510. Thus, a first target image in which a first ROI ROI1 of the raw image (see FIG. 30) is cropped and a second target image in which a second ROI ROI2 of the raw image (see FIG. 31) is cropped may be generated. The same image analysis method is applied to the first and second target images.

As a method of analyzing a target image, a first method of determining a number of valid pixels with a pixel intensity that is greater than or equal to a reference intensity (e.g., a predefined reference intensity) among a plurality of pixels constituting the target image, and a second method of analyzing a pixel intensity of target edges determined according to a defined (e.g., predefined) condition by considering a variance in pixel intensity over time among a plurality of edges present in the target image may be employed.

The pixel intensity represents a degree of brightness (or luminance) of a corresponding pixel. For example, a black pixel may have a pixel intensity of 0, a white pixel may have a pixel intensity of 255, and a gray pixel may have a pixel intensity between 0 and 255. In an embodiment, a light reflectance of the electrode sheet 10 and a light reflectance of a belt of the transport conveyor 100 are different from each other, and by considering that a pixel intensity of a pixel corresponding to the electrode sheet 10 in the target image has a relatively large value, and a pixel intensity of a pixel corresponding to the belt of transport conveyor 100 has a relatively low value, the present embodiment employs a method of analyzing a pixel intensity as a method of detecting whether the electrode sheet 10 is present in the supply region 101 of the transport conveyor 100.

An operation of detecting the first electrode sheet will be described first. As described above, the operation of detecting the first electrode sheet is based on the first method of determining the number of valid pixels with a pixel intensity that is greater than or equal to a reference intensity (e.g., a predefined reference intensity) among a plurality of pixels constituting a target image.

In an embodiment, the processor 510 may generate a binary image by binarizing a plurality of pixels on the basis of a value difference between a pixel intensity of each of the plurality of pixels constituting the target image and the predefined reference intensity. The binarization process of the target image functions as a process of improving detection accuracy of pixels corresponding to the electrode sheet 10 and reducing the time and arithmetic operation resources required for detecting the electrode sheet 10. Here, the reference intensity (e.g., 128) is a reference value for binarizing a plurality of pixels into a pixel with a white pixel intensity (255) and a pixel with a black pixel intensity (0) and may be pre-designed in the processor 510 on the basis of an intent and experimental results of a designer. A pixel with a pixel intensity that is greater than or equal to the reference intensity is defined as a valid pixel.

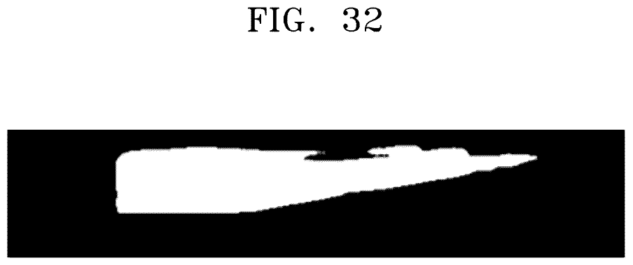

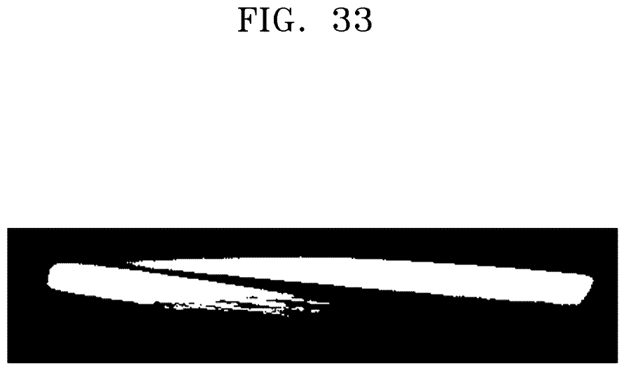

The processor 510 may generate a binary image by binarizing, among a plurality of pixels constituting a target image, a pixel with a pixel intensity that is greater than or equal to the reference intensity to have the white pixel intensity (255) and a pixel with a pixel intensity that is less than the reference intensity to have the black pixel intensity (0). FIG. 32 shows an example of a binarized image generated by binarizing the first target image (corresponding to the first transport conveyor 110), and FIG. 33 shows an example of a binarized image generated by binarizing the second target image (corresponding to the second transport conveyor 120).

When the binarized image is generated, the processor 510 may determine whether the electrode sheet 10 is present in the supply region 101 by comparing the number of valid pixels (i.e., the number of pixels with a pixel intensity that is greater than or equal to the reference intensity) present in the binarized image with the number of predefined reference pixels. The number of reference pixels (e.g., 12,000) may be pre-designed in the processor 510 on the basis of experimental results of a designer on a size of the electrode sheet 10 and the number of valid pixels corresponding to the size. In this case, when the number of valid pixels present in the binarized image is greater than or equal to the number of reference pixels, the processor 510 may determine that the corresponding valid pixels correspond to the electrode sheet 10, thereby determining that the electrode sheet 10 is present in the supply region 101.

In addition to the electrode sheet 10, foreign materials (or particles) with a high light reflectance may be present in the transport conveyor 100, and, thus, the foreign materials with the high light reflectance may appear as valid pixels in the binarized image. Therefore, when the electrode sheet 10 is detected without a process of filtering the valid pixels corresponding to the foreign materials, there is a probability that the foreign materials may be misdetected as the electrode sheet 10, and, also, due to the valid pixels corresponding to the foreign materials, there may occur a problem in that a detection speed of the electrode sheet 10 is reduced and arithmetic operation resources increase.

To remove an influence of the valid pixels corresponding to the foreign materials, the processor 510 may determine one or more contours by clustering valid pixels (i.e., pixels with the pixel intensity that is greater than or equal to the reference intensity) present in the binarized image and then determine whether the electrode sheet 10 is present in the supply region 101 by considering the determined contours. The contour refers to a boundary of a region with the same pixel intensity, and the processor 510 may determine a contour encompassing a valid pixel, for example, by searching for a boundary of a valid pixel with a white pixel intensity (255) in the binarized image using a canny edge detection algorithm.

In the process of determining the contour, since the contour encompassing the valid pixel corresponding to the foreign material is determined together with a contour encompassing a valid pixel corresponding to the electrode sheet 10, first to N^{th} contours may be determined as a plurality of contours (N is a natural number that is greater than or equal to 2). When the number of valid pixels included in the first to N^{th} contours is defined as the number of first to N^{th} pixels, respectively, the processor 510 may determine a maximum value of the number of first to N^{th} pixels. Since a foreign material is usually smaller than the electrode sheet 10 and is present in a dispersed form in the supply region 101, a contour corresponding to the electrode sheet 10 may be specified among the first to N^{th} contours by determining the maximum values of the number of the first to N^{th} pixels. For example, when the number of first pixels has the maximum value among the number of first to Nth pixels, the first contour may be specified as the contour corresponding to the electrode sheet 10, and the second to N^{th} contours may be specified as contours corresponding to the foreign materials.

If the maximum value determined above is greater than or equal to the number of predefined reference pixels, the processor 510 may determine that the electrode sheet 10 is present in the supply region 101.

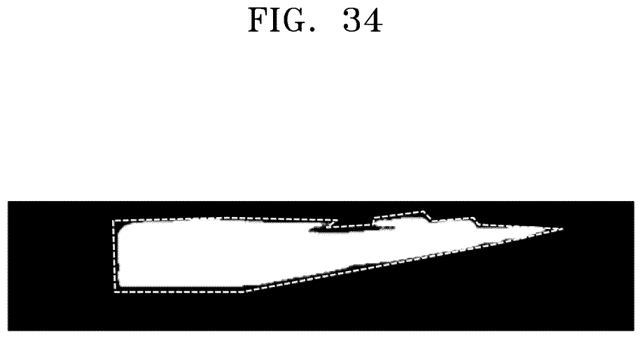

FIG. 34 shows the result of determining a contour in the binarized image of FIG. 32 (corresponding to the first transport conveyor 110). In the case of the binarized image of FIG. 32, only one contour is determined and the number of valid pixels (15,000) included in the contour is greater than or equal to the number of reference pixels (12,000), and it may be determined that the electrode sheet 10 is in the supply region (the first supply region 111 of the first transport conveyor 110).

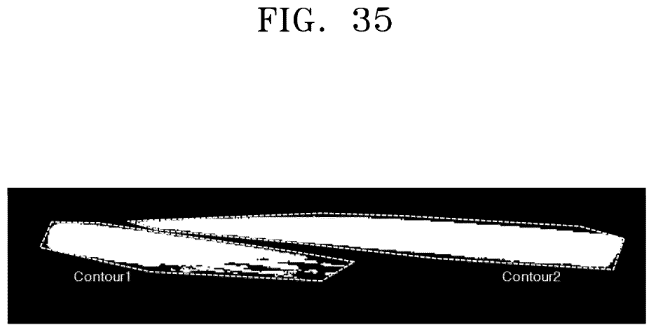

FIG. 35 shows the result of determining a contour in the binarized image of FIG. 33 (corresponding to the second transport conveyor 120). In the case of the binarized image of FIG. 33, first and second contours Contour1 and Contour2 are determined, only the number of valid pixels included in each of the first and second contours, i.e., a maximum number of the second pixels among the number of first pixels and the number of second pixels, is considered in the process of detecting an electrode sheet, and the number of the second pixels (8,000) is less than the number of the reference pixels (12,000) such that it is determined that the electrode sheet 10 is not present in the supply region (the second supply region 121 of the second transport conveyor 120). This case corresponds to a case in which both the first and second contours correspond to foreign materials.

Next, an operation of detecting a second electrode sheet will be described. As described above, the operation of detecting a second electrode sheet is based on a second method of analyzing a pixel intensity of a target edge determined according to a certain condition (e.g., a predefined condition) (herein, defined as a target edge determination condition) by considering a variance in pixel intensity over time among a plurality of edges present in a target image.

In an embodiment, the target edge determination condition, which is predefined by considering the variance in pixel intensity over time, may correspond to a condition for selecting an edge whose pixel intensity remains constant over time among the plurality of edges present in the target image. As described below, the operation of detecting a second electrode sheet is based on the variance in pixel intensity appearing in a column corresponding to the target edge among a plurality of columns constituting a rotated edge image. Therefore, in an embodiment, an edge with less fluctuation in pixel intensity over time among the plurality of edges present in the target image may be selected as the target edge in order to reliably detect the electrode sheet 10.

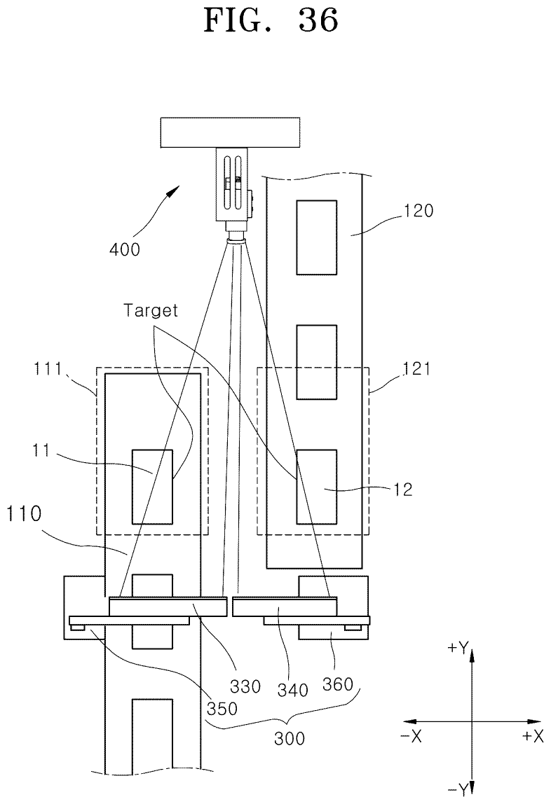

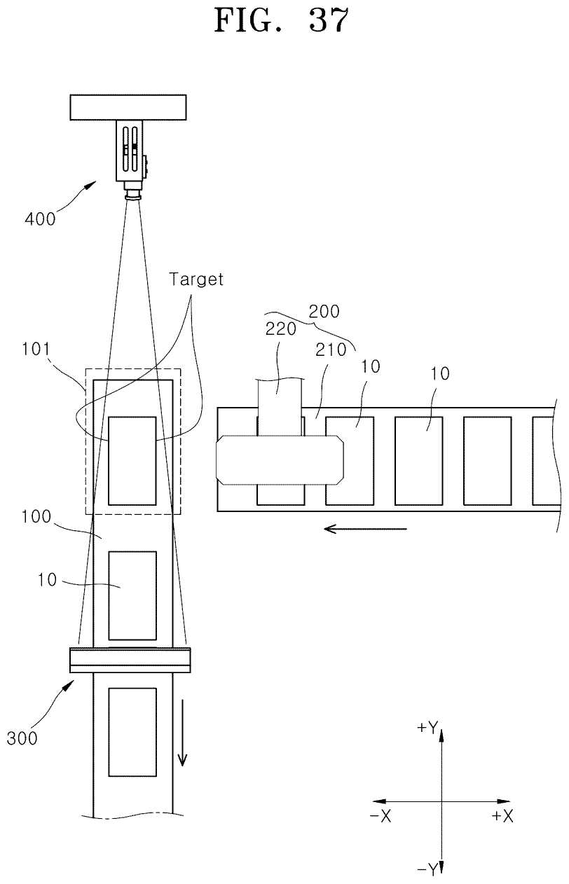

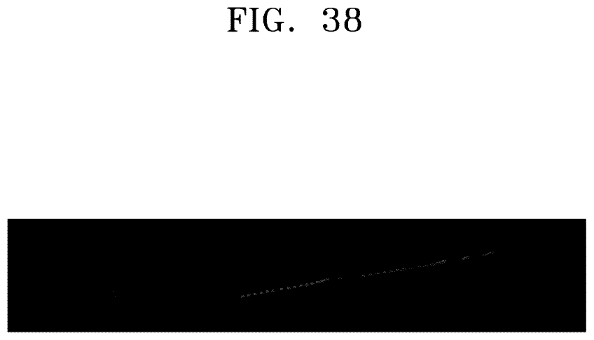

In a structure of the embodiment of FIG. 36 as an example (corresponding to the structure of FIG. 24), reflected light from a right surface target of the first electrode sheet 11 (or a left surface of the second electrode sheet 12) closest to the lighting member 300 and the sensing member 400 may maintain a constant quantity of light such that among a plurality of edges present in the target image, an edge corresponding to the right surface of the first electrode sheet 11 (or an edge corresponding to the left surface of the second electrode sheet 12) may be determined to be the target edge (see FIG. 38). In a structure of the embodiment of FIG. 37 as an example (corresponding to the structure of FIG. 1), a structure is formed such that the lighting member 300, the electrode sheet 10, and the sensing member 400 are formed in a symmetric structure based on a first direction being an axis such that the reflected light of the left surface Target and a right surface Target of the electrode sheet 10 both maintain a constant quantity of light. Thus, in the example of FIG. 37, among the plurality of edges present in the target image, an edge corresponding to the left surface or the right surface of the electrode sheet 10 may be determined to be the target edge. The target edge determination condition may be defined (e.g., predefined) in the processor 510 in response to the structure of the apparatus for transporting an electrode sheet together with quantitative criteria for determining whether the variance in pixel intensity over time remains constant.

In an embodiment, the processor 510 may generate an edge image by extracting only the target edge from the target image and determine whether the electrode sheet 10 is present in the supply region 101 by calculating a variance in pixel intensity of each of a plurality of pixels constituting the generated edge image.

In the present embodiment, as an example of generating an edge image from the target image of FIG. 30, the processor 510 may detect the plurality of edges corresponding to the electrode sheet 10 by applying the canny edge detection algorithm or a Sobel algorithm (Sobel Filter) to the target image, extract only the target edge, which satisfies the target edge determination condition (the edge corresponding to the right surface of the electrode sheet 10 in the example of FIG. 30) among the plurality of detected edges and generate an edge image of which only the target edge is applied. FIG. 38 shows an example of the edge image generated from the target image of FIG. 30.

When the edge image is generated, the processor 510 may determine whether the electrode sheet 10 is present in the supply region 101 by calculating a variance in pixel intensity of each of the plurality of pixels constituting the edge image.

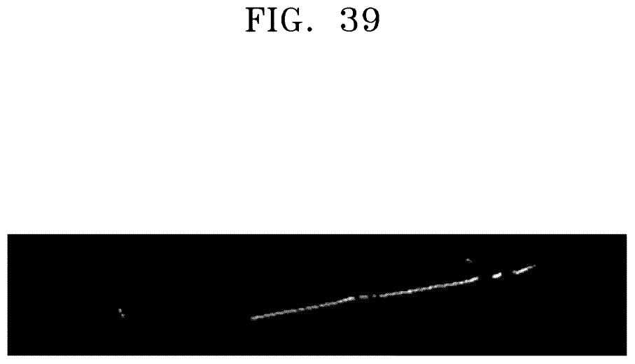

In describing the process of analyzing the edge image in further detail according to an embodiment, the processor 510 may generate a binary image by binarizing the plurality of pixels on the basis of a value difference between a pixel intensity of each of the plurality of pixels constituting the edge image and a predefined reference intensity. The binarization process of the edge image functions as a process of reducing the time and arithmetic operation resources required for an angle calculation of the target edge, which will be described below. Here, the reference intensity (e.g., 128) is a reference value for binarizing a plurality of pixels into a pixel with a white pixel intensity (255) and a pixel with a black pixel intensity (0) and may be pre-designed in the processor 510 on the basis of the intent and experimental results of the designer. FIG. 39 shows an example of the binarized image in which the edge image is binarized.

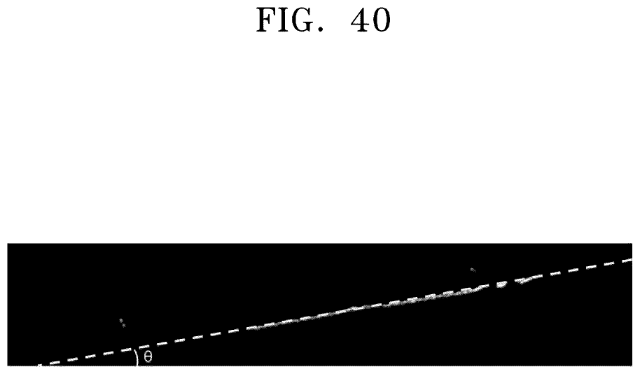

When the binarized image is generated, the processor 510 may calculate an angle between the binarized target edge (in order to distinguish the term from the target edge before the binarization, the binarized target edge is defined as the binarized target edge), which is present in the binarized image and corresponds to the target edge, and a reference axis (e.g., an X-axis) of a coordinate system of the binarized image (see FIG. 40) and rotate the edge image based on the calculated angle. The processor 510 may calculate the angle (acute angle) between a binarization target edge and the reference axis of the coordinate system using a Hough transform (or Hough line detection) algorithm and rotate the edge image using a rotation matrix returned as a result of applying the Hough Transform algorithm. A detailed description of the known Hough transform algorithm will be omitted.

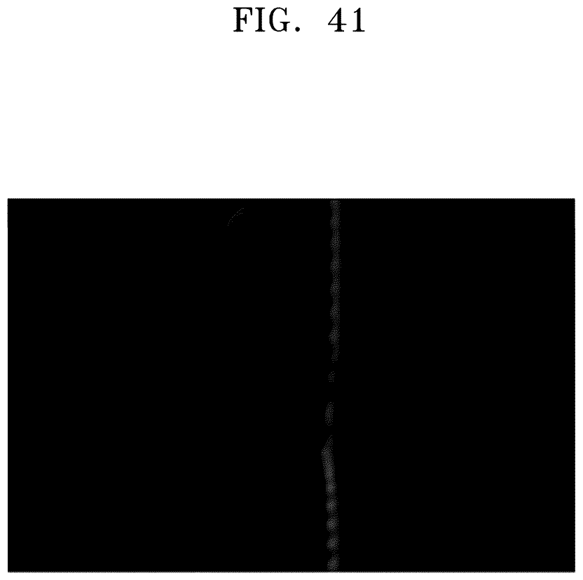

Based on the binarized image, the angle formed between the binarized target edge and the reference axis of the coordinate system of the binarized image is calculated, and the edge image is rotated based on the calculated angle. FIG. 41 shows the rotated edge image (here, the binarized image is not rotated, and the edge image prior to the binarization process is rotated). The rotation of the edge image based on the angle means that the target edge is rotated to be perpendicular to the coordinate system of the edge image (i.e., to be parallel to a Y-axis of the image coordinate system), and in the examples of FIGS. 40 and 41, the rotation may mean a rotation of the edge image counterclockwise by “90-θ” (θ is an angle between the binarization target edge and the reference axis of the coordinate system of the binarized image). Since the edge image is rotated and thus the target edge is formed vertically in the image coordinate system, as described below, the arithmetic operation time and arithmetic operation resources required for the process of determining whether the electrode sheet 10 is present may be reduced by calculating a variance in intensity of the plurality of pixels of the rotated edge image “per column.”

When the edge image is rotated such that the target edge is vertical in the image coordinate system, the processor 510 may determine whether the electrode sheet 10 is present in the supply region 101 by calculating a variance in pixel intensity of each of the plurality of pixels constituting the rotated edge image. In an embodiment, the pixel coordinates corresponding to the target edge on the rotated edge image are recognized by the processor 510, and the processor 510 may operate to calculate only a variance in pixel intensity of each of the plurality of pixels corresponding to an ROI including the target edge. The ROI including the target edge may be, for example, a region within ±α in the X-axis direction based on the X coordinates of the target edge.

When the plurality of pixels of the rotated edge image (FIG. 41) are formed in a matrix structure having a plurality of rows and a plurality of columns, the processor 510 may calculate a plurality of variances in pixel intensity for each column of the rotated edge image. Here, the variance in pixel intensity may be defined as a difference between a calculated value of intensities of pixels constituting the first column of the rotated edge image and a calculated value of intensities of pixels constituting the second column of the rotated edge image. Here, the first and second columns are adjacent columns on the rotated edge image, and the calculated value may be a sum value or an average value.

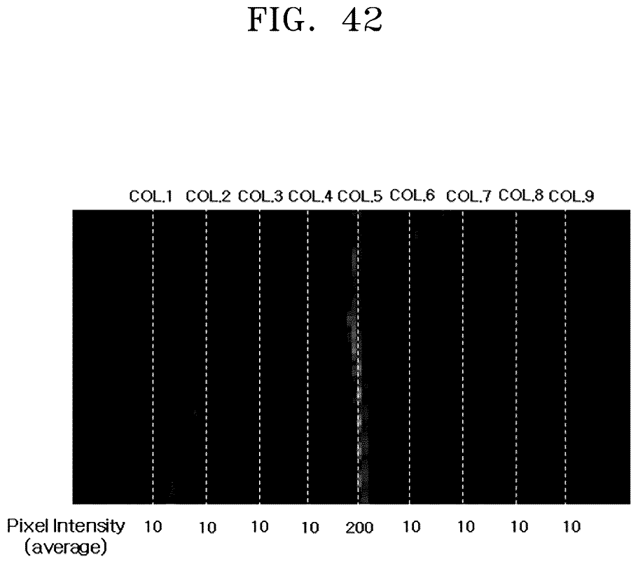

An example of FIG. 42 will be described in further detail. FIG. 42 shows an example of a calculated value (average value) of pixel intensities of each of first to ninth columns of the plurality of pixels of the rotated edge image (the number of columns is an example to help understand the present embodiment, and the number of columns and the number of rows are determined according to a resolution of the rotated edge image). The fifth column corresponds to the target edge. In an embodiment, an average value of pixel intensities of pixels constituting the first column is 10 (i.e., the pixels are close to black in color), and the second to fourth columns and the sixth to ninth columns also have the same average value (10) of the pixel intensities. In an embodiment, an average of pixel intensities of pixels constituting the fifth column is 200 (i.e., the pixels are close to white in color).

In the example of FIG. 42, a variance in pixel intensity of a K^{th} column with respect to a K−1^{th} column (i.e., a value obtained by subtracting an average value of pixel intensities of the K−1^{th} column from an average value of pixel intensities of the K^{th} column) (K is 2 to 9 in the case of FIG. 42) is shown in the following Table 1.

TABLE 1

| | |
|---|---|
| Variance in pixel intensity of second | 0 |
| column with respect to first column | |
| Variance in pixel intensity of third | 0 |
| column with respect to second column | |
| Variance in pixel intensity of fourth | 0 |
| column with respect to third column | |
| Variance in pixel intensity of fifth | 190 |
| column with respect to fourth column | |
| Variance in pixel intensity of sixth | −190 |
| column with respect to fifth column | |
| Variance in pixel intensity of seventh | 0 |
| column with respect to sixth column | |
| Variance in pixel intensity of eighth | 0 |
| column with respect to seventh column | |
| Variance in pixel intensity of ninth | 0 |
| column with respect to eighth column | |

In FIG. 42 and Table 1, the variance in pixel intensity of the fifth column with respect to the fourth column is calculated to be 190 (the value obtained by subtracting 10, which is the average value of the pixel intensities of the fourth column, from 200, which is the average value of the pixel intensities of the fifth column). The variances of the remaining pixel intensities are calculated to have a value of 0. That is, in the rotated edge image in which the target edge is set in the vertical direction (Y-axis direction), the pixels prior to the fifth column show no variance in pixel intensity based on the X-axis direction, drastic variances in pixel intensity occur in the fifth and sixth columns, and the pixels subsequent to the sixth column show no variance in pixel intensity based on the X-axis direction. The variance in pixel intensity in the fifth and sixth columns means that the pixel intensity in the fifth column drastically increases (+190) and then drastically decreases (−190) in the sixth column, which means that a large contrast is formed based on the fifth column. When the maximum value of the variances in the plurality of pixel intensities (which may be an absolute value and may be a value of 190 in Table 1) is greater than or equal to the predefined reference variance (e.g., 150), the processor 510 may determine that a large contrast has been formed due to a boundary of the electrode sheet 10 present in the corresponding column (the fifth column in the above example), thereby determining that electrode sheet 10 is present in the supply region 101. The operations of detecting the first and second electrode sheets described above can be performed independently by the processor 510. That is, when the target image in which a region corresponding to the ROI among the regions of the raw image generated by the sensing member 400 is cropped is generated, the processor 510 independently performs the operation of detecting the first electrode sheet for determining whether the electrode sheet 10 is present in the supply region 101 by determining the number of valid pixels with the pixel intensity that is greater than or equal to the predefined reference intensity among the plurality of pixels constituting the target image and the operation of detecting a second electrode sheet for determining whether the electrode sheet 10 is present in the supply region 101 on the basis of a pixel intensity of a target edge determined according to a predefined condition by considering a variance in pixel intensity over time among a plurality of edges present in the target image. Then, if it is determined that the electrode sheet 10 is present in the supply region 101 in at least one of the operations of detecting first and second electrode sheets, the processor 510 may finally confirm that the electrode sheet 10 is present in the supply region 101.

For example, if it is determined that the electrode sheet 10 is present through the operation of detecting a first electrode sheet, if it is determined that the electrode sheet 10 is present through the operation of detecting the second electrode sheet, or if it is determined that the electrode sheet 10 is present through both the operations of detecting the first and second electrode sheets, the processor 510 may determine (e.g., finally determine) that the electrode sheet 10 is present in the supply region 101. If it is determined that the electrode sheet 10 is not present through both the operations of detecting the first and second electrode sheets, the processor 510 may determine (e.g., finally determine) that the electrode sheet 10 is not present in the supply region 101. Whether or not the electrode sheet 10 is present in the supply region 101 may be detected more accurately through the operations of detecting the first and second electrode sheets performed independently and in parallel.

If it is finally determined that the electrode sheet 10 is present in the supply region 101, the processor 510 may stop the operation of supply member 200 to prevent the electrode sheet 10 from being supplied to the supply region 101. In this case, the processor 510 may transmit a command for stopping the operation of the supply member 200 to the PLC 530, and, accordingly, the PLC 530 may stop the operation of the supply member 200 to prevent or substantially prevent two or more electrode sheets 10 from overlapping in the supply region 101 of the transport conveyor 100.

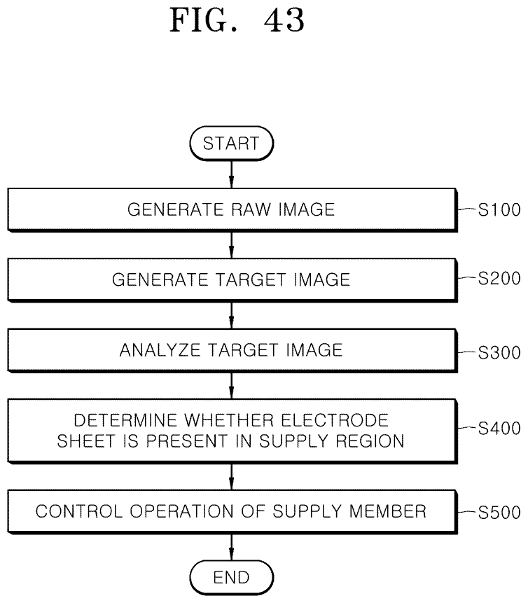

FIGS. 43 to 46 are flowcharts illustrating a method of detecting the electrode sheet according to one embodiment of the present invention. The method of detecting the electrode sheet of the present embodiment will be described with reference to FIGS. 43 to 46, and a description of a portion overlapping the above-described content may be omitted and will be mainly made on a time-series configuration.

First, while light from the lighting member 300 is emitted to the supply region 101 provided in the transport conveyor 100, the sensing member 400 detects reflected light formed when the light emitted from the lighting member 300 is reflected from the supply region 101 to generate a raw image (operation S100).

Subsequently, the processor 510 acquires a target image of the supply region 101 generated in operation S100. Here, the target image is generated on the basis of the result of the sensing member 400 detecting the reflected light formed by the light emitted from the lighting member 300 and reflected from the supply region 101, and the target image is generated (acquired) by cropping a region corresponding to a defined (e.g., predefined) ROI among regions of the raw image (operation S200).

Subsequently, the processor 510 analyzes the target image generated in operation S200 (operation S300). As a method of analyzing the target image in operation S300, a first method of determining the number of valid pixels with a pixel intensity that is greater than or equal to a predefined reference intensity among a plurality of pixels constituting the target image and a second method of analyzing a pixel intensity of a target edge determined according to a defined (e.g., predefined) condition by considering a variance in pixel intensity over time among a plurality of edges present in the target image may be employed, and the first and second methods are applied in parallel and independently in operation S300.

Subsequently, the processor 510 determines whether the electrode sheet 10 is present on the basis of the result of analyzing the target image (operation S400).

Operations S300 and S400 will be described by dividing operations S300 and S400 into an operation of detecting the first electrode sheet according to the first method and an operation of detecting the second electrode sheet according to the second method.

According to the first method, in operation S300, the processor 510 determines whether the electrode sheet 10 is present in the supply region 101 by determining the number of valid pixels with the pixel intensity that are greater than or equal to a defined (e.g., predefined) reference intensity among a plurality of pixels constituting the target image.

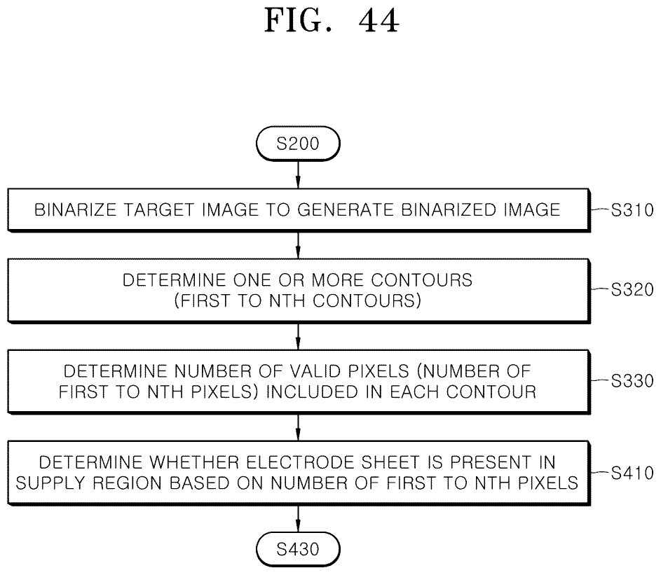

In the operation of detecting the first electrode sheet according to the first method, with reference to FIG. 44, the processor 510 binarizes the plurality of pixels on the basis of the value difference between a pixel intensity of each of the plurality of pixels constituting the target image and the reference intensity, thereby generating a binarized image (operation S310).

Thereafter, the processor 510 determines one or more contours by clustering the valid pixels present in the binarized image (operation S320). In an embodiment, the contour encompassing the valid pixels corresponding to foreign materials are determined together with the contour encompassing the valid pixels corresponding to the electrode sheet 10, and first to N^{th} contours may be determined in operation S320 (N is a natural number that is greater than or equal to 2).

The processor 510 determines the number of valid pixels included in each contour determined in operation S320 (operation S330), that is, determines the number of first to N^{th} pixels as the number of valid pixels included in each of the first to N^{th} contours.

After operation S330 is completed, in operation S400, the processor 510 determines whether the electrode sheet 10 is present in the supply region 101 based on the number of first to N^{th} pixels (operation S410). In operation S410, if the maximum value of the number of first to N^{th} pixels is greater than or equal to the predefined number of reference pixels, the processor 510 determines that the electrode sheet 10 is present in the supply region 101. The determination in operation S410 together with determination in operation S420, which will be described below, corresponds to primary determination considered for finally confirming that the electrode sheet 10 is present in the supply region 101.

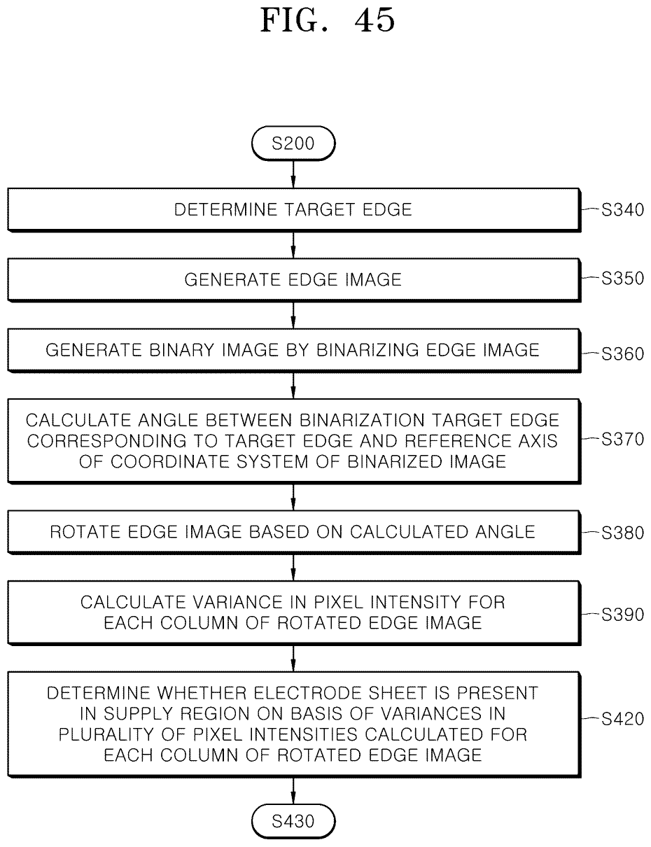

Next, in the operation of detecting the second electrode sheet according to the second method with reference to FIG. 45, the processor 510 determines the target edge according to the target edge determination condition predefined by considering the variance in pixel intensity over time among the plurality of edges present in the target image (operation S340).

Subsequently, the processor 510 extracts only the target edge from the target image to generate the edge image (operation S350).

Then, the processor 510 generates the binary image by binarizing the plurality of pixels on the basis of the value difference between the pixel intensity of each of the plurality of pixels constituting the edge image and a defined (e.g., predefined) reference intensity (operation S360). The target edge is binarized through operation S360.

Next, the processor 510 calculates an angle between a binarization target edge corresponding to the target edge present in the binarization image and a reference axis of the coordinate system of the binarized image (operation S370) and rotates the edge image based on the calculated angle (operation S380).

Subsequently, the processor 510 calculates a variance in pixel intensity of each of a plurality of pixels constituting the rotated edge image (operation S390). In operation S390, the processor 510 calculates a plurality of variances in pixel intensity of each column of the rotated edge image.

After operation S390 is completed, in operation S400, processor 510 determines whether the electrode sheet 10 is present in the supply region 101 on the basis of the plurality of variances in a pixel intensity calculated for each column of the rotated edge image (operation S420). In operation S420, if the maximum value of the plurality of variances in pixel intensities is greater than or equal to a defined (e.g., predefined) reference variance, the processor 510 determines that the electrode sheet 10 is present in the supply region 101. The determination in operation S420 together with the determination in operation S410 corresponds to primary determination considered for finally confirming that the electrode sheet 10 is present in the supply region 101.

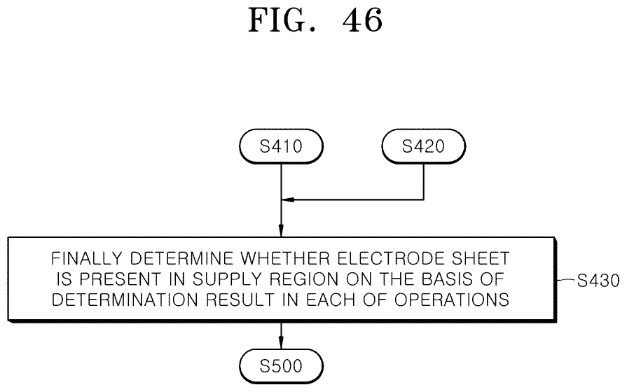

When operations S410 and S420 are completed, as shown in FIG. 46, the processor 510 finally determines whether the electrode sheet 10 is present in the supply region 101 on the basis of the determination result in each of the operations S410 and S420 (operation S430). In operation S430, if it is determined that the electrode sheet 10 is present through operation S140, if it is determined that the electrode sheet 10 is present through operation S420, or if it is determined that the electrode sheet 10 is present through both operations S410 and S420, the processor 510 may finally determine that the electrode sheet 10 is present in the supply region 101. If it is determined that the electrode sheet 10 is not present through both operations S410 and S420, the processor 510 determines that the electrode sheet 10 is not present in the supply region 101.

According to the determination result in operation S400, the processor 510 controls the operation of the supply member 200 (operation S500). In particular, if it is finally determined that the electrode sheet 10 is present in the supply region 101 in operation S400, the processor 510 stops the operation of the supply member 200 to prevent the electrode sheet 10 from being supplied to the supply region 101.

Implementations described herein may also be implemented by, for example, a method or process, an apparatus, a software program, a data stream, or a signal. Even when only discussed in the context in a single form of implementation (e.g., discussed only as a method), the implementation of features discussed may also be implemented in other forms (e.g., an apparatus or program). The apparatus may be implemented in suitable hardware, software, and firmware. The method may be implemented in an apparatus such as a processor, which is generally referred to as a processing device, including, for example, a computer, a microprocessor, an integrated circuit, or a programmable logic device. The processor also includes communication devices such as computers, cellular phones, portable/personal digital assistants (“PDAs”), and other devices that facilitate information communication of between end-users.

According to embodiments of the present disclosure, by detecting the presence or absence of an electrode sheet at a supply position on a transporting conveyor in real time, it is possible to prevent or substantially prevent damage to a device and degradation in the quality of products due to the overlapping of a plurality of electrode sheets.

According to embodiments of the present disclosure, it is possible to prevent or substantially prevent a lighting member and a sensing member from interfering with a supply member in a stack device having a narrow space.

However, aspects and effects obtainable through the present disclosure are not limited to the above aspects and effects, and other technical aspects and effects that are not mentioned will be clearly understood by those skilled in the art from the description of the present disclosure.

As described above, although the present invention has been described with reference to some example embodiments and drawings, the present invention is not limited thereto, and various modifications and variations are possible within the scope of the technical spirit of the present invention and the claims by those skilled in the art to which the present invention pertains.

What is claimed is:

1. An apparatus for detecting an electrode sheet, the apparatus comprising:
a lighting member configured to emit light to a transport conveyor, wherein the transport conveyor comprises a supply region for receiving an electrode sheet and transports the electrode sheet, and the lighting member emits light to the supply region;
a sensor configured to detect reflected light formed by the light emitted from the lighting member and reflected from the supply region; and
a processor configured to analyze a target image of the supply region generated on the basis of a result of the sensor detecting the reflected light and determine whether the electrode sheet is present in the supply region.

2. The apparatus as claimed in claim 1, wherein the processor is configured to determine whether the electrode sheet is present in the supply region in a manner in which the target image is analyzed on the basis of a pixel intensity of each of a plurality of pixels constituting the target image.

3. The apparatus as claimed in claim 2, wherein the processor is configured to determine whether the electrode sheet is present in the supply region in a manner in which a number of valid pixels with a pixel intensity that is greater than or equal to a defined reference intensity is determined among the plurality of pixels constituting the target image.

4. The apparatus as claimed in claim 3, wherein the processor is configured to
generate a binarized image by binarizing the plurality of pixels on the basis of a value difference between the pixel intensity of each of the plurality of pixels constituting the target image and a reference intensity;
determine one or more contours by clustering the valid pixels present in the binarized image; and
determine whether the electrode sheet is present in the supply region based on the number of valid pixels included in the one or more contours.

5. The apparatus as claimed in claim 4, wherein
the one or more contours include first to N^{th} contours, where N is a natural number greater than or equal to 2; and
if the number of valid pixels included in each of the first to N^{th} contours is defined as the number of first to N^{th} pixels, the processor determines that the electrode sheet is present in the supply region if a maximum value of the number of first to N^{th} pixels is greater than or equal to a defined number of reference pixels.

6. The apparatus as claimed in claim 2, wherein the processor is configured to determine whether the electrode sheet is present in the supply region on the basis of a pixel intensity of a target edge determined according to a target edge determination condition defined by considering a variance in pixel intensity over time among a plurality of edges present in the target image.

7. The apparatus as claimed in claim 6, wherein the processor is configured to generate an edge image by extracting only the target edge from the target image and determine whether the electrode sheet is present in the supply region in a manner in which a variance in pixel intensity of each of a plurality of pixels constituting the generated edge image is calculated.

8. The apparatus as claimed in claim 7, wherein the processor is configured to
generate a binarized image by binarizing the plurality of pixels on the basis of a value difference between the pixel intensity of each of the plurality of pixels constituting the edge image and a predefined reference intensity;
calculate an angle formed between the binarized target edge corresponding to the target edge present in the binarized image and a reference axis of the coordinate system of the binarized image;
rotate the edge image based on the calculated angle; and
determine whether the electrode sheet is present in the supply region in a manner in which a variance in pixel intensity of each of the plurality of pixels constituting the rotated edge image is calculated.

9. The apparatus as claimed in claim 8, wherein the processor is configured to calculate a plurality of variances in pixel intensity for each column of the rotated edge image and, if a maximum value of the plurality of variance is greater than a defined reference variance, determine that the electrode sheet is present in the supply region.

10. The apparatus as claimed in claim 9, wherein
the variance in pixel intensity is a difference between a calculated value of intensities of pixels constituting a first column of the rotated edge image and a calculated value of intensities of pixels constituting a second column of the rotated edge image;
the first and second columns are adjacent columns on the rotated edge image;
and the calculated value is a sum value or an average value.

11. The apparatus as claimed in claim 2, wherein
the processor is configured to independently perform operations of detecting first and second electrode sheets, and if it is determined that the electrode sheet is present in the supply region as a result of at least one of the operations of detecting the first and second electrode sheets, the processor determines that the electrode sheet is present in the supply region;
the detecting the first electrode sheet comprises determining whether the electrode sheet is present in the supply region in a manner in which the number of valid pixels with a pixel intensity that is greater than or equal to a defined reference intensity is determined among the plurality of pixels constituting the target image; and
the detecting the second electrode sheet comprises determining whether the electrode sheet is present in the supply region on the basis of a pixel intensity of a target edge determined according to a target edge determination condition defined by considering a variance in the pixel intensity over time among a plurality of edges present in the target image.

12. The apparatus as claimed in claim 1, further comprising a supplier configured to supply the electrode sheet to the supply region,
wherein, if it is determined that the electrode sheet is present in the supply region, the processor stops an operation of the supplier to prevent the electrode sheet from being supplied to the supply region.

13. The apparatus as claimed in claim 1, wherein the processor is configured to generate the target image by cropping a region corresponding to a defined region of interest in a raw image generated by the sensor if the sensor detects the reflected light.

14. An apparatus for transporting an electrode sheet, the apparatus comprising:
a transport conveyor comprising a supply region for receiving an electrode sheet and configured to transport the electrode sheet;
a supplier configured to supply the electrode sheet to the supply region;
a lighting member configured to emit light to the supply region;
a sensor configured to detect reflected light formed by the light emitted from the lighting member and reflected from the supply region; and
a controller configured to analyze a target image of the supply region generated on the basis of a result of the sensor detecting the reflected light, determine whether the electrode sheet is present in the supply region, and control an operation of the supplier according to a result of the determination.

15. A method of detecting an electrode sheet, the method comprising:
acquiring, by a processor, a target image of a supply region while light from a lighting member is emitted to a supply region of a transport conveyor, wherein the transport conveyor comprises the supply region to receive the electrode sheet and transports the electrode sheet, a sensor detects reflected light of the light emitted from the lighting member and reflected from the supply region, and the target image is generated on the basis of a result of the sensor detecting the reflected light;
analyzing, by the processor, the target image; and
determining, by the processor, whether the electrode sheet is present on the basis of an analysis result of the target image.

16. The method as claimed in claim 15, wherein in the analyzing of the target image, the processor analyzes the target image on the basis of a pixel intensity of each of a plurality of pixels constituting the target image.

17. The method as claimed in claim 16, wherein in the analyzing of the target image, the processor determines whether the electrode sheet is present in the supply region in a manner in which a number of valid pixels with a pixel intensity that is greater than or equal to a certain reference intensity is determined among the plurality of pixels constituting the target image.

18. The method as claimed in claim 16, wherein in the analyzing of the target image, the processor determines whether the electrode sheet is present in the supply region on the basis of a pixel intensity of a target edge determined according to a target edge determination condition defined by considering a variance in pixel intensity over time among a plurality of edges present in the target image.

19. The method as claimed in claim 16, wherein in the analyzing of the target image, the processor independently performs: an operation of detecting a first electrode sheet by determining whether the electrode sheet is present in the supply region in a manner in which the number of valid pixels with a pixel intensity that is greater than or equal to a certain reference intensity is determined among the plurality of pixels constituting the target image; and an operation of detecting a second electrode sheet by determining whether the electrode sheet is present in the supply region on the basis of a pixel intensity of a target edge determined according to a target edge determination condition defined by considering a variance in pixel intensity over time among a plurality of edges present in the target image, and
in the determination of whether the electrode sheet is present, if it is determined that the electrode sheet is present in the supply region as a result of at least one of the operations of detecting the first and second electrode sheets, the processor determines that the electrode sheet is present in the supply region.

20. The method as claimed in claim 15, further comprising, if it is determined that the electrode sheet is present in the supply region, stopping, by the processor, an operation of a supplier to prevent the electrode sheet from being supplied to the supply region, wherein the supplier supplies the electrode sheet to the supply region.
